(19) United States
(12) Patent Application Publication
(10) Pub. No.: US 2025/0304468 A1
(43) Pub. Date: Oct. 2, 2025

(54) SYNTHESIS OF NANOPOROUS POLYPHENOL-BASED COORDINATION POLYMER FRAMEWORKS AND METHODS OF USE THEREOF

(71) Applicant: University of North Carolina at Greensboro, Greensboro, NC (US)

(72) Inventors: Hemali Rathnayake, Summerfield, NC (US); Sheeba Dawood, Greensboro, NC (US)

(21) Appl. No.: 19/237,675

(22) Filed: Jun. 13, 2025

Related U.S. Application Data
(63) Continuation of application No. 17/710,492, filed on Mar. 31, 2022.
Application No. 17/710,492 is a continuation of application No. PCT/US20/50607, filed on Sep. 14, 2020.
(60) Provisional application No. 62/911,543, filed on Oct. 7, 2019.

(51) Int. Cl. C02F 1/28; C02F 101/20; C07F 15/02

(52) U.S. Cl. CPC C02F 1/288; C07F 15/025; C02F 1/281; C02F 1/285; C02F 2101/20; C02F 2303/04

(57) ABSTRACT

Method of synthesizing tannic acid-coordinated Fe(III)-coordination polymer frameworks (TA-Fe(III)-CPFs) includes coordinating tannic acid (TA) with an aqueous solution of iron(III) acetate (Fe(OAc)3) to form a mixture. The mixture is subjected to ultrasonic vibration for a predetermined period of time to initiate a rapid complex formation reaction. The method additionally includes forming tannic acid-coordinated Fe(III)-coordination polymer framework (TA-Fe(III)-CPFs) from the mixture.

### CROSS-REFERENCE TO RELATED APPLICATIONS

This application is a continuation application of U.S. patent application Ser. No. 17/710,492 filed on Mar. 31, 2022, which is a continuation application of PCT Patent Application No. PCT/US20/50607 filed on Sep. 14, 2020, which claims priority to U.S. Provisional Patent Application No. 62/911,543 filed on Oct. 7, 2019, the entire contents of which are incorporated by reference herein.

### TECHNICAL FIELD

The present invention relates generally to the field of nanotechnology, and particularly, to a system and method of fabricating nanoporous polymer materials such as tannic acid-coordinated Fe(III)-coordination polymer frameworks (TA-Fe(III)-CPFs).

### BACKGROUND

Lithium is an element that is abundantly available in nature. Lithium is mainly obtained from minerals and continental brines sources such as salt lakes and salt flats. Lithium is typically processed into lithium carbonate and lithium hydroxide. Lithium carbonate is widely employed in ceramics, glasses, and pharmaceutical sectors whereas lithium hydroxide is prominently used by electric vehicle manufacturers. Energy storage, air treatment, glasses and ceramics, and greases and lubricants are some major applications that require lithium. Energy storage includes portable electronic devices, hybrid vehicles, battery electric vehicles, and power storage.

Most of the lithium reserves are present in mineral ore and brine solution form. For decades, commercial lithium production relied on mineral ores. Extraction of lithium from these ores is significantly expensive when compared to brine solution. As a result, many of the lithium producers are transitioning towards extraction from brine solution. Typically, brine solution is available from underground reservoirs, and contains high concentrations of dissolved salts that include elements such as lithium, potassium and sodium. A conventional method for extracting lithium includes solar evaporation, which requires large evaporation ponds over a period of 12-24 months with suitable climatic conditions. This technique however results in low levels of lithium recovery. Current methods of lithium extraction can require high capital outlay depending on the size of the well or the brine pond. Two additional methods used for lithium extraction include ion exchange and solvent exchange; however, these two technologies are not capable of producing high purity lithium in large scale due to low selectivity for lithium recovery. Accordingly, opportunities exist for improved methods for selectively extracting lithium from brine solution that yield high lithium recovery and low-cost production.

Recent advancements in nanotechnology-enabled water remediation technologies have been appealing in advancing conventional water purification technologies. However, adaptability of these technologies on a large scale remains a challenge due to factors such as high cost, lack of scalability, and high-risk potential of adverse environmental impacts. Accordingly, opportunities exist for improved fluid treatment methods by way of improved nanotechnology-enabled technologies.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclosed herein is a method of synthesizing tannic acid-coordinated Fe(III)-coordination polymer frameworks (TA-Fe(III)-CPFs). According to various embodiments, the method comprises coordinating tannic acid (TA) with a Fe(III) substance to yield a mixture of coordination complexes possessing different coordination stoichiometries between pyrogallol units and Fe(III) units. The method also includes subjecting the mixture to ultrasonic vibration from a sonicator for a predetermined period of time to initiate a rapid complex formation reaction. The method further includes forming tannic acid-coordinated Fe(III)-coordination polymer framework (TA-Fe(III)-CPFs) from the mixture.

According to one or more embodiments, the method further includes subjecting the TA-Fe(III)-CPFs to a further ultrasonic vibration; applying a centrifugal force to separate solid particles comprising TA-Fe(III)-CPFs from the mixture; and, washing the solid particles with water to yield TA-Fe(III)-CPFs nanobeads having nanoporosity.

According to one or more embodiments, a cross-section of a nanobead pore is between approximately 5 nm and approximately 10 nm.

According to one or more embodiments, a cross-section of a nanobead pore is less than approximately 2 nm.

According to one or more embodiments, one or more steps of the method are conducted at room temperature.

According to one or more embodiments, a coordination bond is formed between a Fe(III) ion and a hydroxyl unit of a pyrogallol unit of a tannic acid (TA) molecule, wherein a core structure of the tannic acid molecule remains intact.

According to one or more embodiments, a Fe(III) ion binds onto a respective phenol group of a tannic acid (TA) molecule after eliminating a hydroxyl unit of the tannic acid (TA) molecule.

Disclosed herein is a method of synthesizing tannic acid-silsesquioxane nanoparticles (TA-NPs). According to various embodiments, the method comprises functionalizing a pyrogallol unit within each tannic acid (TA) molecule with a silane precursor through Williamson ether synthesis by reacting tannic acid (TA) with an alkoxy silane precursor to form a sol-gel reactive site on the TA molecule, wherein the sol-gel is formed by converting monomers into a polymer dispersed in a colloidal solution via base-catalyzed hydrolysis and condensation. The method also includes forming an integrated network site on a periphery of the TA molecule to generate a crude product. The method additionally includes concentrating the crude product by subjecting it to a vacuum, and washing the concentrated crude product with hexane to create a refined product. The method further includes treating the refined product with de-ionized water to remove unreacted TA to yield tannic acid-silsesquioxane nanoparticles (TA-NPs).

According to one or more embodiments, the silane precursor comprises organosilane.

According to one or more embodiments, the sol-gel reactive site is formed by alkylating a hydroxy group of a phenol unit present in a tannic acid (TA) molecule with an organosilane precursor.

According to one or more embodiments, a pyrogallol hydroxy group of the tannic acid (TA) molecule is functionalized with a benzyl unit of an organoalkoxysilane molecule.

According to one or more embodiments, the method further includes dispersing the sol-gel in an aqueous-based solvent to produce a coating ink; and fabricating a soft dielectric thin film of nanoparticles from the coating ink, the soft dielectric thin film comprising one or more of: a flexible surface, and an irregular surface.

According to one or more embodiments, the method further includes: applying a centrifugal force to separate solid particles from the refined product; washing the solid particles with water; treating the solid particles with an ethanol solution; and, collecting TA-NP particles in solid form.

According to one or more embodiments, a carbonyl stretching of a silane molecule is lower than an ester carbonyl stretching of the tannic acid (TA) molecule.

According to one or more embodiments, a TA-silane molecule portion of the tannic acid-silsesquioxane nanoparticle (TA-NP) is thermally stable up to 425° C.

According to one or more embodiments, a TA molecule portion of the tannic acid-silsesquioxane nanoparticle (TA-NP) is thermally stable up to 525° C.

Disclosed herein is a method of extracting metal ions from an aqueous solution. According to various embodiments, the method comprises: providing a molecular sieving coordination polymer framework (CPF) material derived from tannin or tannic acid (TA); and passing a liquid substance through the molecular sieving CPF material to extract metal ions present in the liquid substance.

According to one or more embodiments, the metal ions are extracted as a TA-metal ion-silsesquioxane nanomaterial.

According to one or more embodiments, the metal ions comprise one or more of: an alkali metal, a transition metal, and a heavy metal.

According to one or more embodiments, the metal ions comprise lithium, wherein the lithium is recovered in the form of one or more of: lithium carbonate, and lithium ion coordinated CPF.

According to one or more embodiments, the liquid substance comprises one or more of: salt brine and a non-traditional water resource.

According to one or more embodiments, the molecular sieving coordination polymer framework (CPF) material comprises an absorbent bead having a pore having a cross-section of approximately less than 2 nm.

According to one or more embodiments, the molecular sieving coordination polymer framework (CPF) material comprises a pore, wherein a cross-section of the pore is tailored for a size of a specific metal ion to be extracted.

According to one or more embodiments, the molecular sieving coordination polymer framework (CPF) material exhibits a red-shifted peak at 330 nm when viewed under an ultra-violet-visible spectrophotometer.

According to one or more embodiments, the molecular sieving coordination polymer framework (CPF) material comprises one or more of: a TA-metal ion coordinated complex nanomaterial, a TA-Fe(III) coordinated complex nanomaterial, a TA-silane derivative nanomaterial, a transition metal ion coordinated hierarchically structured nanomaterial, and a TA-silsesquioxane nanomaterial.

According to one or more embodiments, the molecular sieving coordination polymer framework (CPF) material is in a form of one or more of: a microparticle, a nanoparticle, a nanorod, a nanoribbon, and a nanobead.

According to one or more embodiments, the molecular sieving coordination polymer framework (CPF) material of nanoporosity is a form of one or more of: a filter, a liner, a membrane, a sorbent bead, a filler material, a point-of-use fluorescent probe, and a filter mat.

According to one or more embodiments, the method further includes using the molecular sieving coordination polymer framework (CPF) material for one or more of: multiplex detecting of a heavy metal ion or a contaminant, selectively extracting the heavy metal ion or the contaminant, disinfecting water, and decontaminating water.

Disclosed herein is a method for extracting lithium from lithium-bearing salt brine. According to various embodiments, the method comprises: passing lithium-bearing salt brine through a filter comprising a nanoporous molecular sieving coordination polymer framework (CPF) material to extract lithium ions present in the lithium-bearing salt brine. The method also includes causing the lithium ions to react with the nanoporous molecular sieving coordination polymer framework (CPF) material to form a lithium ion coordinated CPF nanocomposite material. The method further includes capturing the filtrate residue after removing the lithium ion coordinated CPF nanocomposite material.

According to one or more embodiments, the method further includes treating the lithium ion coordinated CPF nanocomposite material with carbonic acid to yield lithium carbonate.

According to one or more embodiments, the method further includes compacting and bagging the lithium ion coordinated CPF nanocomposite material.

According to one or more embodiments, the method further includes passing the filtrate residue through a nanoporous coordination polymer framework (CPF) filter material to extract or remove one or more of: contaminants and heavy metal ions present in the filtrate residue.

According to one or more embodiments, the method further includes boiling and condensing the filtrate residue to yield usable water.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1A is a graphical representation of a comparison of UV-vis spectral traces of TA, just after added Fe⁺³ solution, and after 1 hour of reaction time (taken during the reaction in water), and the final TA-Fe(III)-CPF (spectrum was taken after re-disperse in ethanol), according to an embodiment of the present invention.

FIG. 1B is a graphical representation illustrating colors of initial TA solution (before Fe⁺³ added), and after 1-hour reaction time, according to an embodiment of the present invention.

FIGS. 2A-2C illustrate scanning electron microscopy (SEM) images of morphologies of nanobeads of TA-Fe(III)-CPFs formed as reaction progresses and after sonication. FIG. 2A illustrate SEM images taken of a reaction mixture immediately after FE (II) acetate is added; FIG. 2B illustrate SEM images taken of the reaction mixture one hour after FE (II) acetate is added; and, FIG. 2C illustrate SEM images taken of the reaction mixture one hour after FE (II) acetate is added followed by sonication, according to an embodiment of the present invention.

FIG. 3 illustrate transmission electron microscopy (TEM) images of nanobeads formed by self-assembled TA-Fe(III)-CPFs, according to an embodiment of the present invention.

FIG. 4A is a graphical representation illustrating FTIR spectra of TA, TA-silane, and TA-NPs; and FIG. 4B is a graphical representation illustrating UV-vis spectra of TA, TA-silane, and TA-NPs, according to an embodiment of the present invention.

FIGS. 5A-5C illustrate scanning electron microscopy (SEM) images of nanobeads of TA-NPs; and FIGS. 5D and 5E illustrate transmission electron microscopy (TEM) images of nanobeads of TA-NPs, according to an embodiment of the present invention.

FIGS. 6A and 6B illustrates scanning electron microscopy (SEM) images of TA-Li(I)-CPFs, according to an embodiment of the present invention.

FIG. 7 illustrates a flow chart of a lithium extraction process, according to an embodiment of the present invention.

FIGS. 8A-8C illustrate design and synthesis of various TA-CPFs to achieve targeted structure-property functions, according to an embodiment of the present invention.

FIG. 9 illustrates an exemplary bacterial disinfection mechanism of multi-functional TA-Fe(III) CPF nanobeads in contaminated water, according to an embodiment of the present invention.

FIG. 10 illustrates an exemplary multiplex membrane formed of TA-Fe(III) CPFs used as a fluorescence probe, according to an embodiment of the present invention.

FIG. 11 illustrates exemplary applications of multi-functional TA-Fe(III) CPFs, according to an embodiment of the present invention.

FIGS. 12A-12D illustrate scanning electron microscopy (SEM) and transmission electron microscopy (TEM) images depicting morphologies of nanobeads of TA-Fe(III)-CPFs, according to an embodiment of the present invention.

FIG. 13A illustrates a scanning electron microscopy (SEM) image of a morphology of nanofibers TA-Fe(III)-CPFs/poly-acrylonitrile composites; FIG. 13B illustrates a scanning electron microscopy (SEM) image of a morphology of TA-NPs/poly-acrylonitrile composites; and FIG. 13C illustrates an image of a large-area nanofiber mat, according to an embodiment of the present invention.

FIG. 14 illustrates exemplary chemical structures and a synthesis scheme of TA-Fe(III)-CPFs, according to an embodiment of the present invention.

FIG. 15 illustrates exemplary chemical structures and a synthesis scheme of preparing Tannic acid-functionalized silane, according to an embodiment of the present invention.

FIG. 16 illustrates exemplary chemical structures and a synthesis scheme of preparing TA-Li(I)-CPF, according to an embodiment of the present invention.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the presently disclosed subject matter can advantageously provide for efficient lithium extraction that can selectively extract and recover high-grade lithium. Embodiments of the presently disclosed subject matter can provide for selectively extracting lithium from brine solution resulting in high lithium recovery and low-cost production and conversion of lithium to lithium carbonate. Embodiments of the presently disclosed subject matter can be advantageously applied by entities that extract lithium from brine solution. Embodiments of the presently disclosed subject matter can significantly reduce the cost, and cut down the extraction time, literally from 2 years to a couple of hours, resulting in low capital intensive. Oil companies and lithium producers can benefit from the embodiments described herein. Embodiments of the presently disclosed subject matter can be advantageously applied in at least the following potential markets: oil companies, lithium companies, energy storage battery manufacturing companies, oil drilling, oil refining, lithium ion battery manufacturing, electric automobiles, lithium manufacturing, and energy storage device production.

Most of lithium reserves are present in mineral ore and brine solution. Commercial lithium production previously relied on mineral ores. Extraction of lithium from these ores was found to be significantly expensive when compared to brine solution. As a result, many of the lithium producers are transitioning towards brine solutions. Brine solution is an underground reservoir that contains high concentrations of dissolved salts such as lithium, potassium and sodium. Currently, most of the lithium produces use conventional techniques such as solar evaporation, which requires large evaporation ponds, with high operational costs, over a period of 12-24 months with suitable climatic conditions. This results in low levels of lithium recovery. Accordingly, existing technologies are inadequate to produce high purity lithium in large scale due to low selectivity for lithium recovery, and current methods of lithium extraction can cost thousands of dollars depending on the size of the well and or brine pond.

Among recent lithium extraction technologies from brine or liquid solutions, ion exchange and solvent exchange are two technologies that have been relatively cost effective. However, these two technologies are not adequate to produce high purity lithium in large scale due to low selectivity for lithium recovery and degradation of ion-exchange column materials. In particular, most inorganic ion exchange materials absorb lithium ions from a liquid source while releasing hydrogen ions, which facilitate to elute lithium ions into the acid medium during the ion exchange process and absorb hydrogen ions from the medium. During this process, high acidity can dissolve and degrade absorbing materials during the lithium elution in acid as well as during lithium uptake in liquid resources. This results in decreased performance and lifespan of the component materials. To overcome the degradability and dissolution of materials, an ion exchange method for lithium extraction using coated inorganic ion exchange materials can be used in which inorganic ion exchange materials are protected from degradation and dissolution by introducing a variety of polymer coating materials onto ion exchange absorbent particles. The absorbent particles are prepared from a variety of metal oxide derivatives, with a combination of selected synthetic polymers as coating materials. However, a major drawback of this method is the lack of high selectivity and binding affinity in the presence of other ions due to their larger pore size and less-dense polymer functionality; this is because selectivity is dependent on the coating material's thickness and on the functional density of binding sites present in the outer layer of the polymer coating.

By contrast, embodiments of the presently disclosed subject matter can help improve the selectivity of the extraction process to increase the yield of the lithium recovery process. Embodiments as disclosed herein can be used in ponds of various sizes and shapes. In various embodiments as disclosed herein, the high selectivity for lithium ions over other cations and anions can be achieved through tailoring the pore size of the coordination polymer framework thereby providing for fast extraction and recovery of lithium from brines and salt lakes. In one embodiment, a large area fibrous mat weaved coordination polymer framework derived from natural tannins and transition metal ions can be used to extract lithium. The development of coordination polymer framework (CPF) nanomaterials as described herein can open a new avenue for use of these lithium-coordinated CPF nanomaterials in solid-state lithium ion batteries as solid-state electrolytes, anode materials, and separators directly as-is, i.e., without converting the extracted product to lithium carbonate or lithium hydroxide. Embodiments disclosed herein can advantageously find applications in lithium ion batteries, health care industries, and pharmaceutical industries. Embodiments as disclosed herein can provide for producing low-cost environmentally benign materials in large-scale to extract lithium to produce high purity lithium; this can advantageously move the lithium extraction market towards clean technology with high lithium recovery and production. Embodiments as disclosed herein can accordingly provide for an efficient and rapid metal ion extraction technology for extracting metal ion such as, for example, lithium ion from sources including crude oil, brine, and wastewater, among others.

Embodiments as disclosed herein can provide for an efficient and rapid lithium extraction technology that involves novel, environmental benign, and low-cost molecular sieving materials with high density functionality and selectivity for lithium ions, while providing tailored nanoporosity for selective lithium ion extraction from other metal ion contaminants. Embodiments as disclosed herein can provide for an innovative nanotechnology-enabled, simple, rapid, and low-cost lithium extraction method that includes the ability to control the functionality, pore dimension, and selectivity at molecular level, resulting in enhanced molecular sieving ability. The molecular sieving absorbent developed using the methods described herein can be used as absorbent beads in the nanometer range and as filter membranes, mats, and fillers that process high density nanoporosity (1-2 nm pore diameter). According to embodiments as disclosed herein, a series of coordination polymer frameworks (CPF) can be designed and synthesized from naturally available polyphenol tannic acid (TA) and various transition metal ions.

Embodiments as disclosed herein utilize a coordination polymer framework (CPF) that possesses molecular sieving ability, tailor-able pore size, and functional coordination sites, among others—that can be designed or tailored to the material to be extracted or removed. Embodiments as disclosed herein can further provide for high binding affinity for selective metal ions coordination. Various embodiments as disclosed herein provide for the development of a natural polyphenol based-CPF through a rapid and scalable synthesis method to make nanoporous beads of metal-coordinated polyphenol complex, Fe(III)-Tannic acid CPF beads from a naturally abundant tannin derivatives in combination with Fe(III) salts. A low-cost scalable synthesis method provided by the embodiments disclosed herein combined with supramolecular chemistry principles can advantageously provide possibilities for manipulating function and porosity of tannic acid-based CPF at the nanoscale level for coordinating specific metal ions, including smallest metal ions such as, for e.g., lithium ions, thereby providing for the extraction of lithium ions from brine and converting the extracted lithium ion into pure lithium carbonate or into used lithium coordinated CPF composites for use in lithium ion batteries, for example. Embodiments as disclosed herein provide for a rapid and scalable synthesis method of synthesizing Fe(III)-tannic acid (TA) nanoporous beads and nanoporous tannic acid-silsesquioxane nanoparticles that can selectively extract alkali metal ions (Li+ and Na+) and other heavy metals from aqueous solutions, in some embodiments.

Embodiments as disclosed herein can also provide for the designing of a series of novel molecular sieving CPFs derived from natural and abundant polyphenol derivative tannin that is present in plants. Embodiments as disclosed herein can be used in the preparation of various products such as molecular sieves, filters, fibrous mats, and filtering membranes, which can in turn be used in extraction, filtration, and/or purification processes that use these products in the form of beads or sorbents or sorbent beads, for example, for metal ion extraction as well as for water purification and remediation.

Various embodiments of the presently disclosed subject matter include CPFs that can contain any transition metal ion coordinated CPFs hierarchical structures, any silane functionalized TAs, and any TA silsesquioxane nanomaterials. Owing to rich oxygen binding sites available in TA as well as the ability of TA to form metal ion chelated coordination network, various embodiments of the presently disclosed subject matter can allow for novel materials design strategies, novel preparation procedures, and self-assembly processes to make hierarchical structures. Various embodiments of the presently disclosed subject matter can further provide for prototypes of CPFs-based filters, membranes, sorbent beads, and mats with high dense in nanoporosity. Various embodiments of the presently disclosed subject matter as described herein also include novel synthesis methods of making nanoporous beads of tannic acid functionalized silsesquioxanes, their hierarchical microstructures and nanoparticles, and nanomaterials of tannic acid-iron(III) coordination frameworks.

Tannic acid or tannin (TA) is a natural polyphenol present in various plants and tree barks and can be extracted in large scale for low cost. Owing to its pyrogallol and catechol structural units, it exhibits valuable chemical and physical properties such as antioxidant, antibacterial, and biodegradability as one of the cheapest natural abundant functional materials. Its five pyrogallol and five catechol groups provide multiple bonding sites with diverse interactions, including hydrogen bond, ionic bond, coordinate bond, and hydrophobic interactions; TA is further rich in oxygen sites for selective lithium binding, for example. The formation of a coordination complex that possesses metal-phenolic networks via the coordination between catechol/galloyl functional groups and metal ions is beneficial to various aspects of the presently disclosed subject matter. A variety of tannic acid-metal coordinated complexes has been applied as either thin films or particles with tailored properties and in the formation of novel metallogels. Utilizing TA as either porogen or additive component in materials science has attracted attention due to not only cheap, environmentally friendly and nontoxic but also a non-surfactant template. For example, TA can be used as a porogen for tuning the porosity of other inorganic particles to make mesoporous materials with tunable mesopore sizes ranging from 6 to 13 nm. As a further example, dopamine functionalized tannic acid templated mesoporous silica nanoparticles can be used as a sorbent material for efficient removal of copper (II) ion from aqueous solutions.

Embodiments as disclosed herein can include various products and applications, including the following: (1) nanoporous beads of Fe(III)-Tannic acid CPF nanostructure, composition, and preparation; (2) tannic acid-silsesquioxane CPF nanostructures, composition, and preparation; (3) lithium coordinated Tannic acid CPF nanostructures, composition, and preparation; (4) extraction of lithium ion from saltwater/brine, produced water using naturally abundant polyphenol-based CPF (broadly defined), not only limited to Tannic acid-based metal coordination frameworks and its silsesquioxane nanostructures, colloids, aerogels, and sols but also for all polyphenolic-based CPFs and their silsesquioxane derivatives; (5) polyphenol-based CPFs for potential applicability towards water purification, heavy metal extraction, lithium ion extraction from salt water, and other crude waste water, including brine, and produced water ponds; and, (6) alkali metal ion (Li+ and Na+) coordinated CPF nanostructures, composites, and their derivatives for potential applications in components of lithium ion batteries and energy storage.

Embodiments as disclosed herein include, among others, the following: (1) hierarchical structures of a variety of TA-metal ion coordinated complexes, for e.g., TA-Fe(III) coordination complexes; (2) TA-silane derivatives that prepares functionalizing hydroxy groups of pyrogallol units in TA with a variety of alkoxy silanes; (3) TA-silsesquioxane nanoparticles, microparticles, nanorods, nanoribbons with different functionality, dimensions, and porosity; and, (4) nanomaterials, hierarchical structures, microparticles, beads, prepared from combinations of un-modified TA, TA-Fe(III) coordination complex, and TA silanes. Some embodiment examples with their chemical structures are shown in the accompanying figures. According to various embodiments of the presently disclosed subject matter, the materials design and preparation stages can include design strategy, precursor preparation, and adsorbent beads preparation on TA-metal ion coordination polymer frameworks.

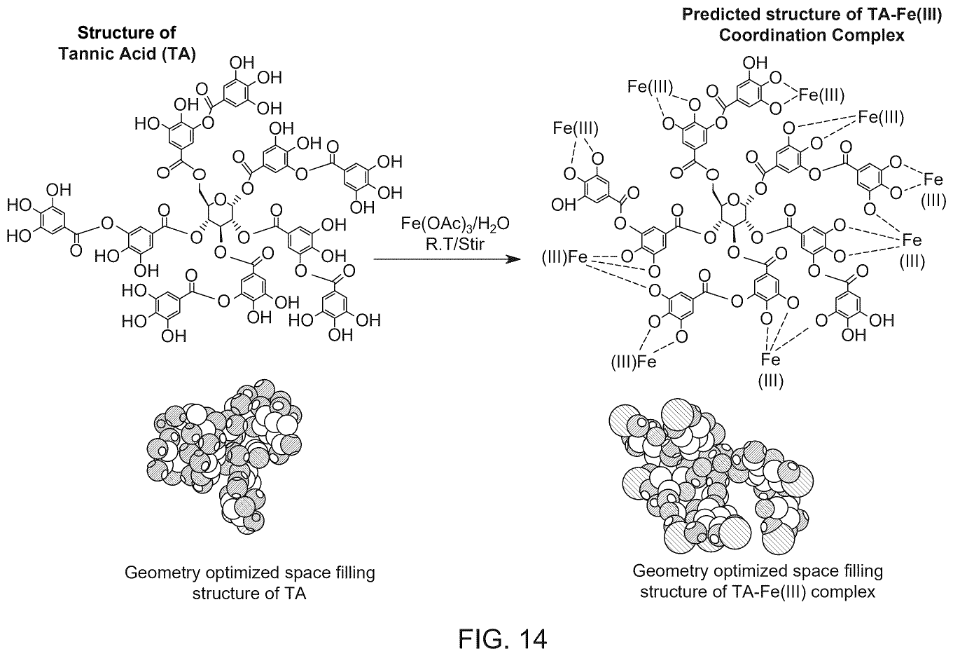

Various embodiments of the presently disclosed subject matter use TA as the core material to produce novel hierarchical coordination frameworks (CPFs) for metal ion extraction, in particular, targeting extraction of lithium from lithium sources, and water remediation and heavy metal ion removal from non-traditional water resources. Preliminary studies by the inventors involved the synthesizing of a series of novel nanomaterials derived from tannic acid-based coordination polymer frameworks. The description herein lays out preparation, characterization, optical properties, and particle morphologies of nanomaterials formed from self-assembled coordination polymer frameworks of TA-Fe(III) coordination complex and base-catalyzed sol-gel polymerization of tannic acid functionalized silanes as shown, for example, in Scheme 1 illustrated in FIG. 14.

Synthesis, characterization, and morphologies of TA-Fe(III)-CPFs nanobeads according to at least one embodiment includes a simple and rapid synthesis method developed to make highly porous nanobeads of TA-coordinated Fe(III)-coordination polymer frameworks (TA-Fe(III)-CPFs). Nanobeads are prepared by coordinating TA with iron(III) acetate (Fe(OAc)3) in water followed by sonication. The chemistry for the preparation of TA-Fe(III) CPFs is depicted in a first scheme (Scheme 1 is illustrated in FIG. 14) along with the space filling structure of the geometry optimized tannic acid (TA) structure and the structure of iron-coordinated complex. A simple and rapid synthesis method has been developed by the inventors to make highly porous nanobeads of TA-Fe(III)-CPFs for the first time.

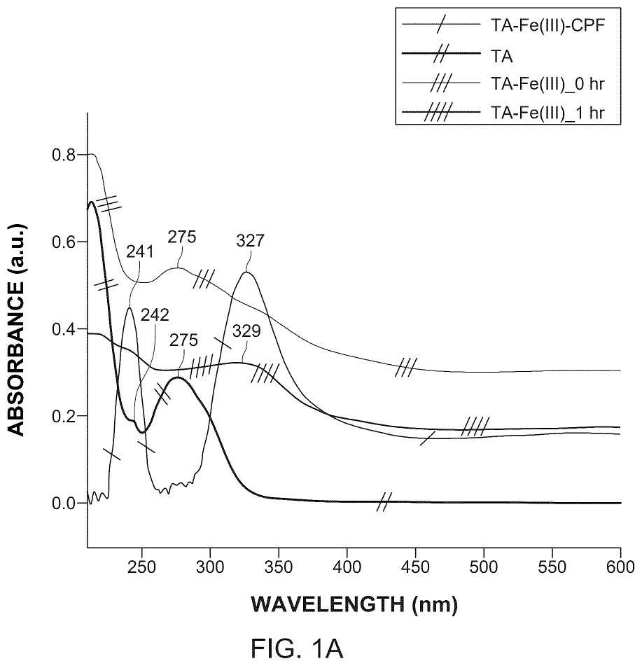

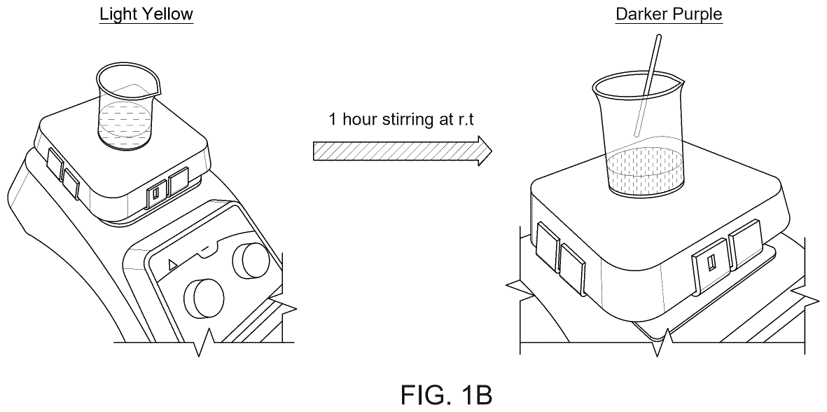

TA-Fe(III)-CPF nanoporous beads are accordingly prepared by using simple and rapid complex formation reaction in water at room temperature. As depicted in FIG. 1A, the complex formation is monitored by collecting UV-vis spectra before and just after adding iron solution, and after one-hour reaction time. During the initial studies, the inventors noticed that within an hour, the reaction mixture turned from clear solution to light purple and eventually into dark purple suspension (see FIG. 1B).

The UV-vis traces confirmed the reaction progress and metal-coordinated complex formation. The spectrum exhibits a broader red-shifted peak at 330 nm, with lack of well resolved vibronic absorption maximum for TA's pyrogallol moieties at 218 nm (see FIG. 1A). TA-Fe(III)-CPF Nanobeads were collected after sonicated, an additional hour followed by centrifugation and repeated washing with water. The nanobeads prepared in this manner can be fully characterized by powder X-ray diffraction, XPS, FTIR and UV-Vis spectroscopies. In the initial analysis, the FTIR spectral traces confirm the formation of coordination bond between Fe(III) and pyrogallol moieties' hydroxyl groups, while intact the tannic acid core structure. The reduction in hydroxyl stretching at 3300 cm-1 further evidences the successful binding of Fe⁺³ onto tannic acid phenol groups.

The nanobeads prepared in this manner is fully characterized by techniques including powder X-ray diffraction, XPS, FTIR (Fourier-transform infrared spectroscopy) and UV-Vis spectroscopy. The FTIR spectral traces confirm the formation of coordination bond between Fe(III) and hydroxyl groups of pyrogallol moieties, while leaving intact the tannic acid (TA) molecule's core structure. The reduction in hydroxyl stretching at 3300 cm⁻¹ further evidences the successful binding of Fe⁺³ ions onto tannic acid (TA) phenol groups complex by causing hydroxyl groups of the TA to disappear.

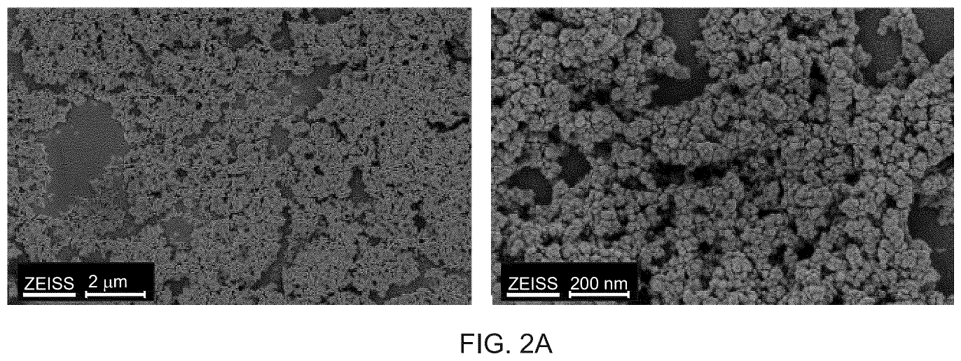

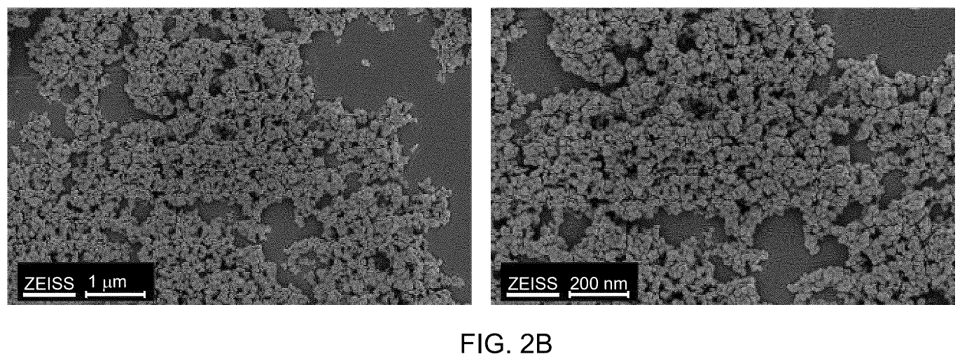

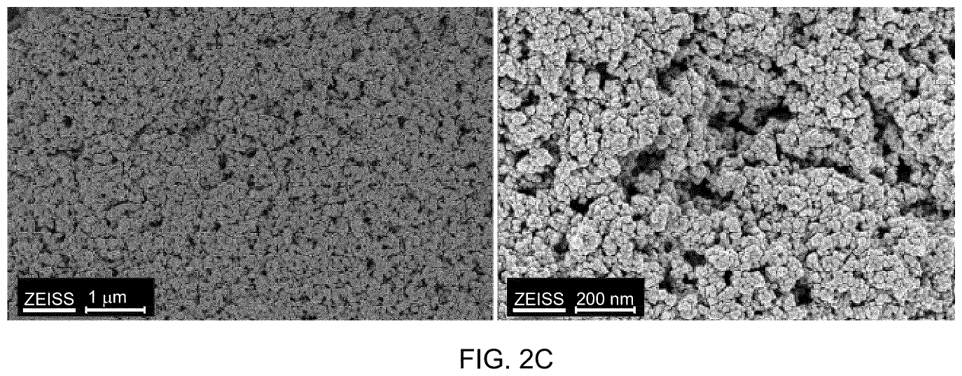

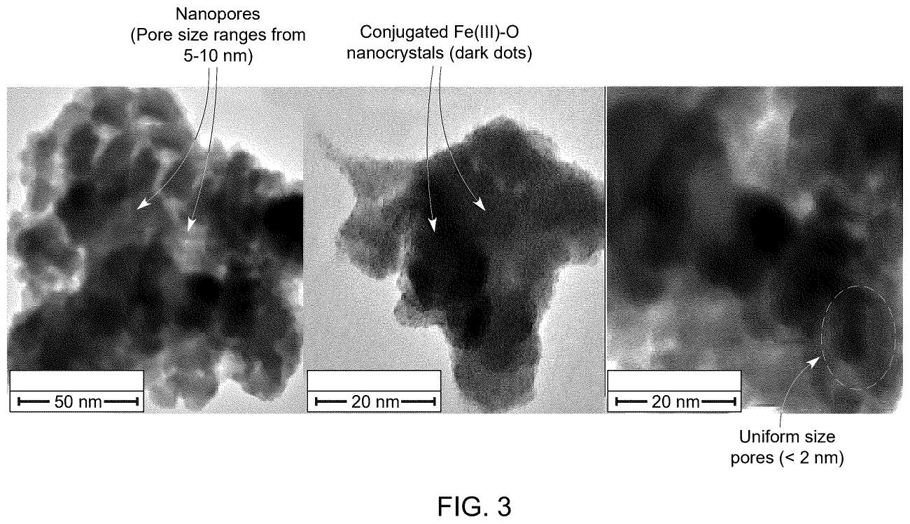

After extraction of the synthesized tannic acid-coordinated Fe(III)-coordination polymer frameworks (TA-Fe(III)-CPFs) in bead form, surface morphologies of the beads, their nanoporosity, and particle crystallinity are studied through scanning electron microscopy (SEM), and transmission electron microscopy (TEM) techniques combined with dark field selected area diffraction mode (SAED) techniques, as depicted in FIGS. 2A-2C. Further, formation of nanobeads and their morphology changes are studied with the reaction progress by taking small aliquot out from the reaction mixture, followed by drop casting the same on a silicon substrate for SEM analysis. The sample prepared immediately after the iron solution is added exhibited aggregated nanoparticles with particle size ranging from 50 nm to 200 nm. The particles formed after one hour from the time when the iron solution is added are larger in size compared to the nanoparticles formed at the initial stage. Particles collected after the sonication step exhibit same or similar morphology as the nanoparticles formed at initial stage and after one-hour reaction time. After a one-hour of reaction time interval followed by sonication and re-dispersion in ethanol, transmission electron microscopy images taken at that instant (as shown in FIG. 3) reveal larger nanopores (with pore size ranging from 5 nm to 10 nm) and uniform size smaller nanopores (with pore size<2 nm). In the beads, self-assembled nanocrystals of iron-coordinated hydroxylate (Fe⁺³—O) sites are clearly visible and support the presence of coordinated iron onto hydroxyl units of pyrogallol units.

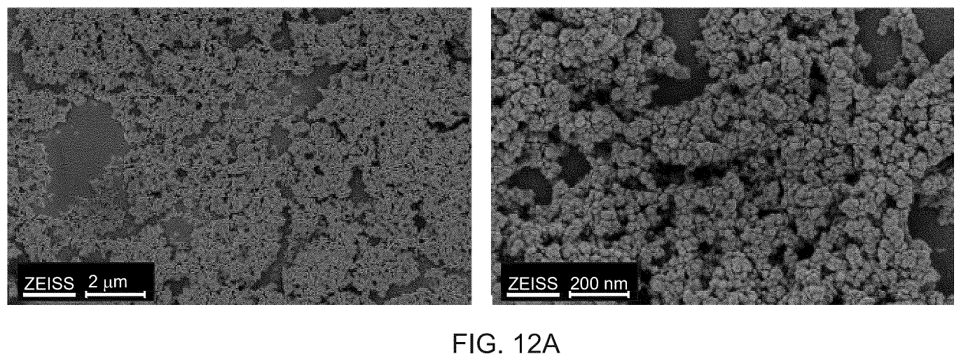

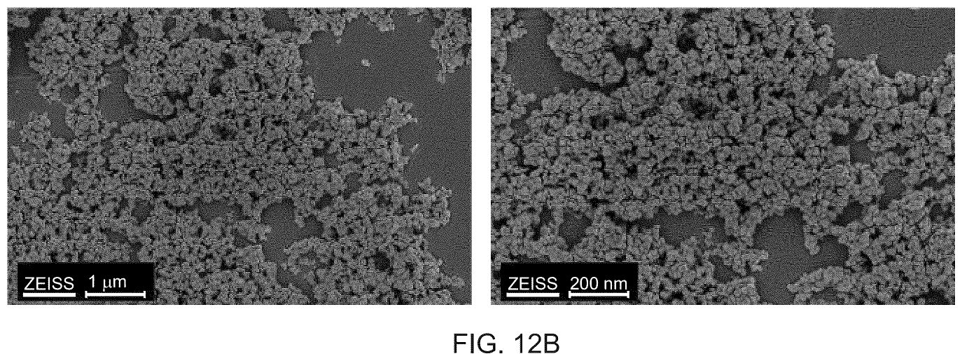

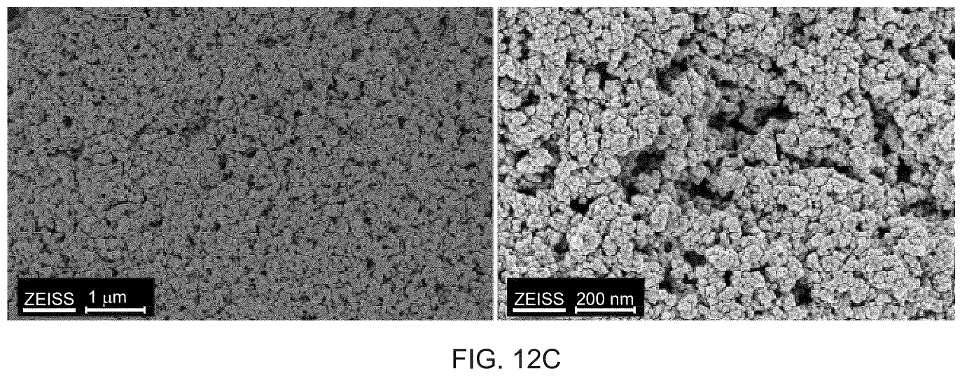

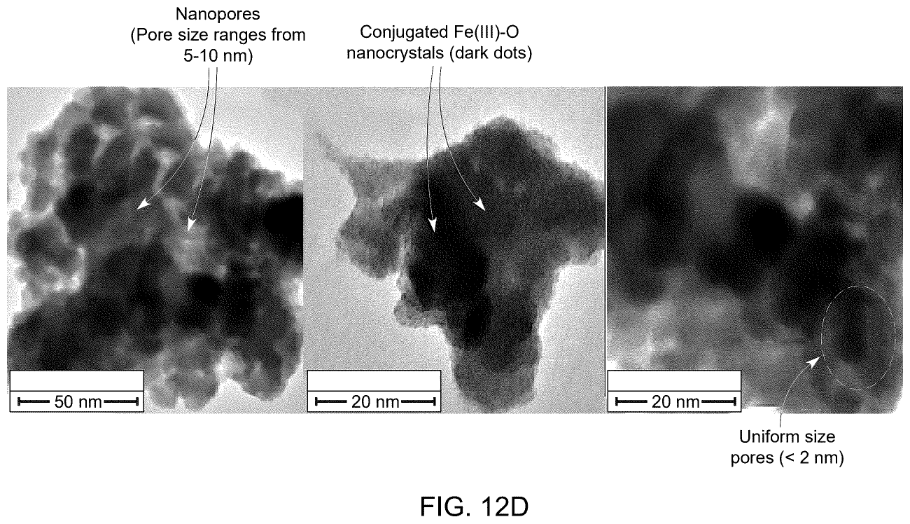

Surface morphologies of beads fabricated by the methods disclosed herein, and their nanoporosity were studied through scanning electron microscopy (SEM) and transmission electron microscopy (TEM) and are depicted in FIG. 12. The nanobeads formation and their morphology changes were studied with the reaction progress by taking small aliquot out from the reaction followed by drop-casting on a silicon substrate for SEM analysis. The sample, prepared just after added iron solution, exhibits aggregated nanoparticles with particle size ranged from 50 to 200 nm. The particles formed after 1 hour were larger in size compared to the nanoparticles formed at the initial stage. Particles collected after sonication exhibit same morphology as nanoparticles formed at initial stage and after 1-hour reaction time. Transmission electron microscopy images, taken after 1-hours reaction followed by sonication and re-dispersed in ethanol (see FIG. 12d), reveal larger nanopores (pore size ranged from 5 nm-10 nm) and uniform size smaller nanopores (pore size<2 nm). The beads' self-assembled nanocrystals are clearly visible. The formation of iron-coordinated hydroxylate (Fe⁺³—O) bonds were identified by XPS and Raman spectroscopy and confirm the successful complex formation with pyrogallol units in tannic acid. The methods as described herein can be used to prepare Fe(III)-TA CPFs in larger scale for low-cost production of molecular sieves for water remediation and point-of-use sensors to detect microbial contaminants.

It was observed by the inventors that the tannic acid's pyrogallol units were functionalized with a silane precursor to introduce sol-gel reactive site onto the tannic acid periphery. The sol-gel polymerization follows a hydrolysis and condensation process in the presence of a base to produce nanoparticles' sols with silsesquioxane cores. These colloidal sols also can disperse in aqueous-based solvents to produce ink that can coat on any flexible and irregular surfaces using simple self-assembly driven spray coating techniques.

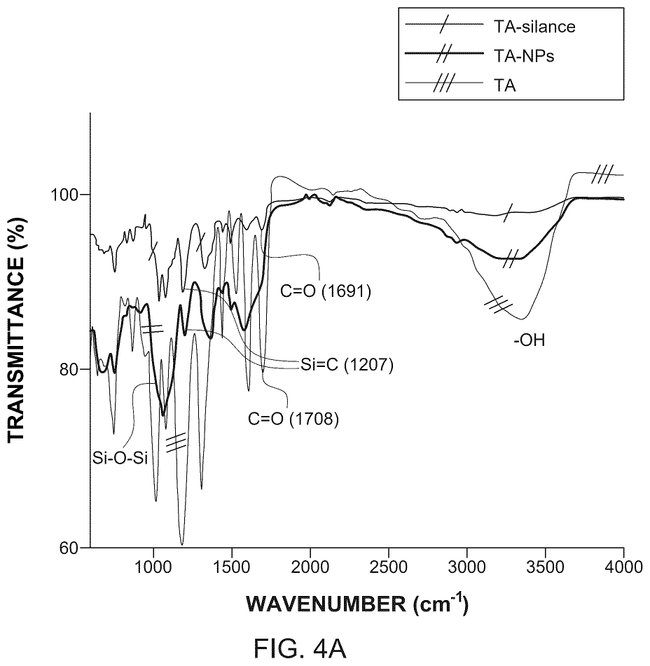

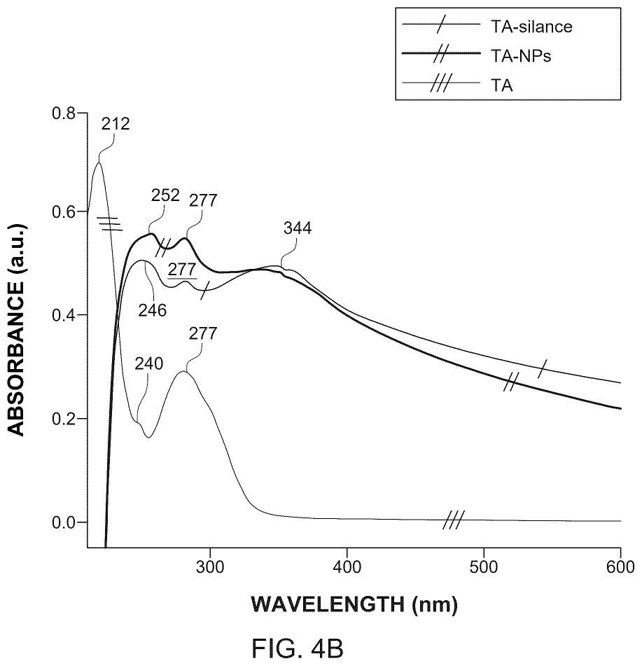

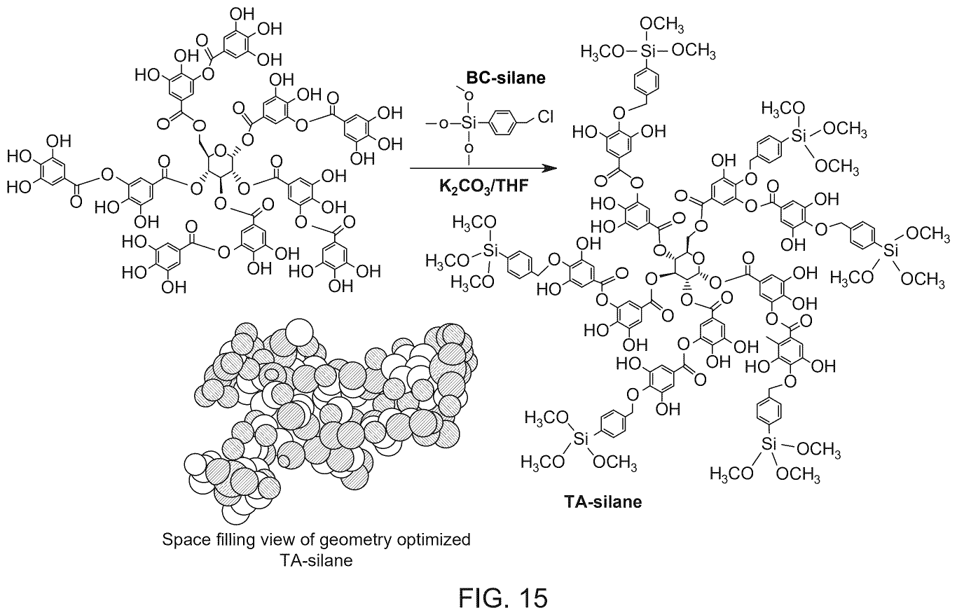

As depicted in Scheme 2 (see FIG. 15), sol-gel reactive sites were introduced randomly onto tannic acid backbone upon alkylating phenol units' hydroxy groups with an organosilane precursor, using Williamson ether synthesis. The crude TA-silane, prepared in this manner, was concentrated under vacuum and was further purified by washing with hexane followed by de-ionized water to remove unreacted tannic acid and other products. Although, there is a tendency to hydrolyze silane units' methoxy groups during the washing with de-ionized water, the FTIR analysis showed that there was no noticeable broad IR (infra-red) stretching at 3000-3500 cm⁻¹ for hydroxyl groups (FIG. 4(a)). The TA-silane's FTIR spectrum (FIG. 4A confirmed the presence of characteristics bands for Si—O (1120-1025 cm⁻¹) and Si—C(1207 cm⁻¹). The ester carbonyls and aromatic C—C (carbon-to-carbon) stretching vibrations were observed at 1692 and 1602-1511 cm⁻¹ respectively. The silane's carbonyl stretching is lower than the tannic acid's ester carbonyls stretching. The UV-vis absorption spectrum was collected in ethanol and compared with the TA's absorption spectrum. In general, the tannic acid's absorption spectrum exhibits two absorption maxima at 212 nm and 277 nm with a weak shoulder peak at 240 nm. Comparison to TA absorption, in the TA-silane absorption spectrum, the absorption maxima at 212 nm disappeared and show enhanced absorption at 246 nm, which was little red shifted to the shoulder peak of TA at 240 nm. While the original TA absorption at 277 nm was less pronounced. The additional absorption peak at 344 nm in TA-silane confirms the functionalization of pyrogallol hydroxy groups with benzyl units of organoalkoxy silanes.

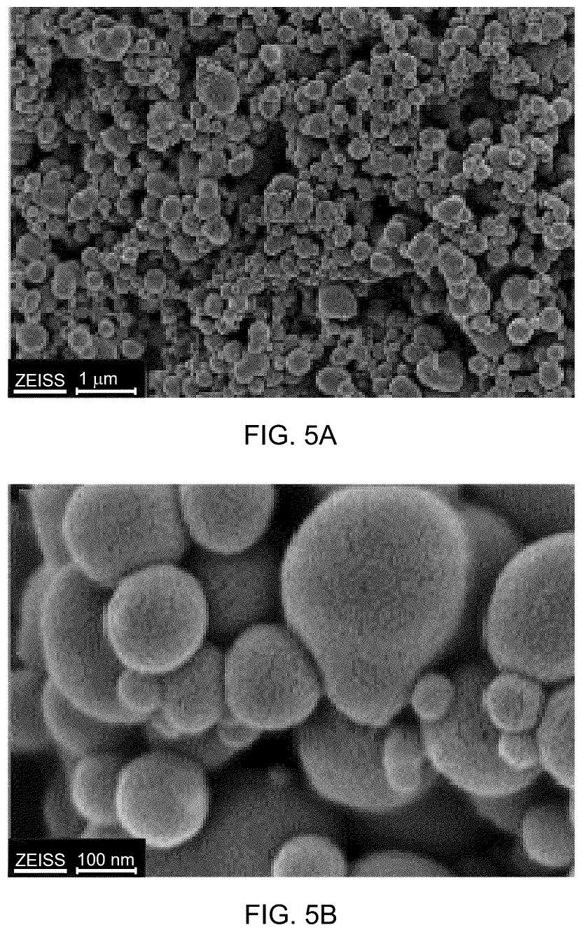

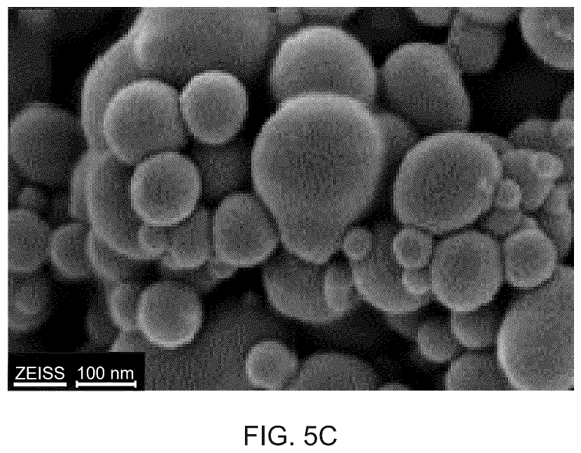

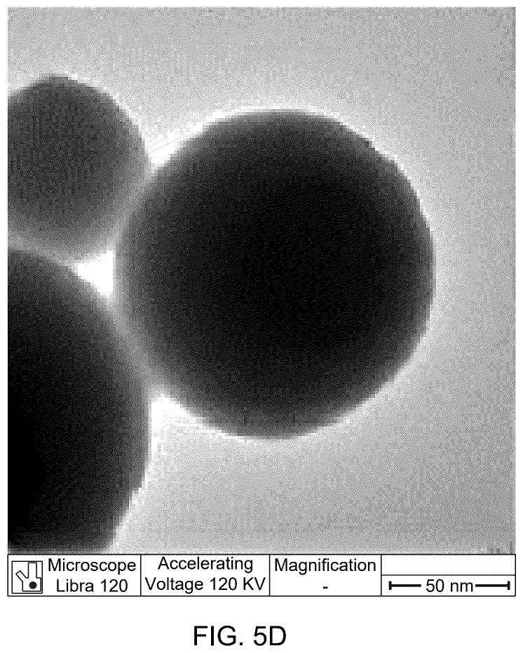

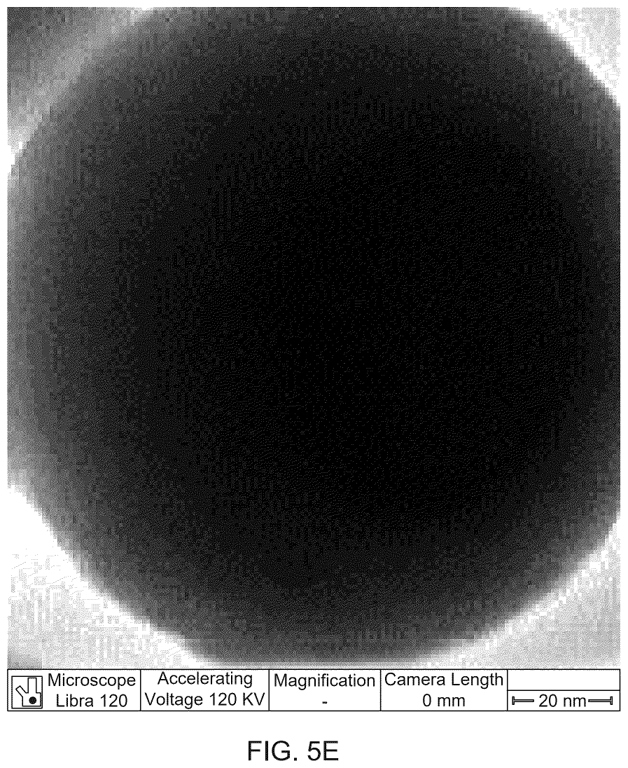

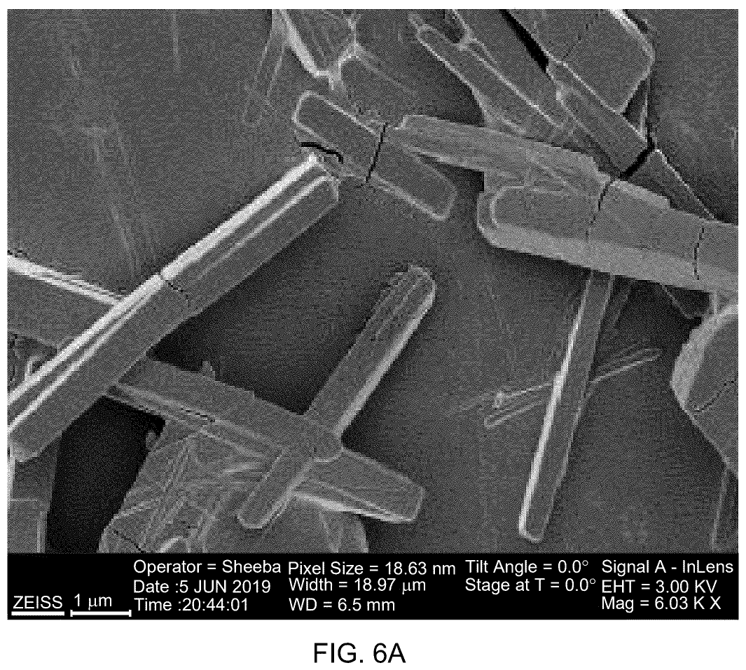

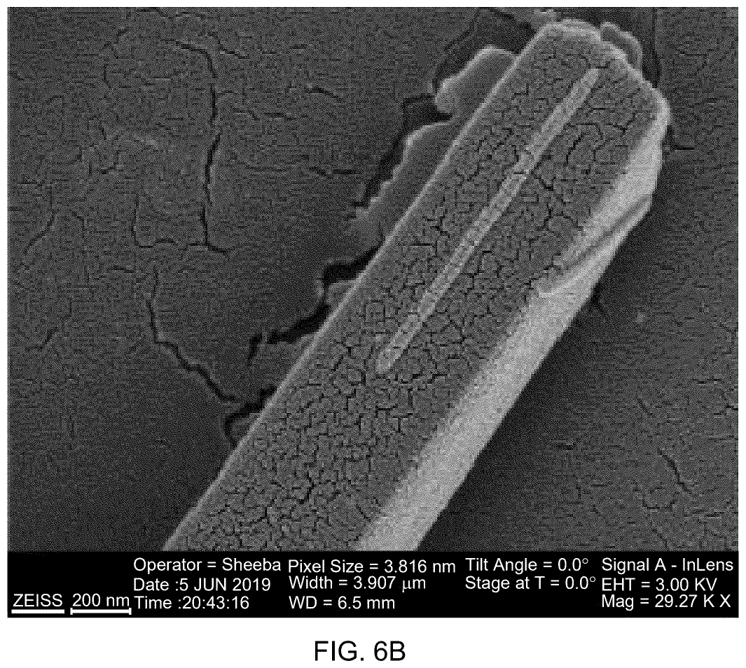

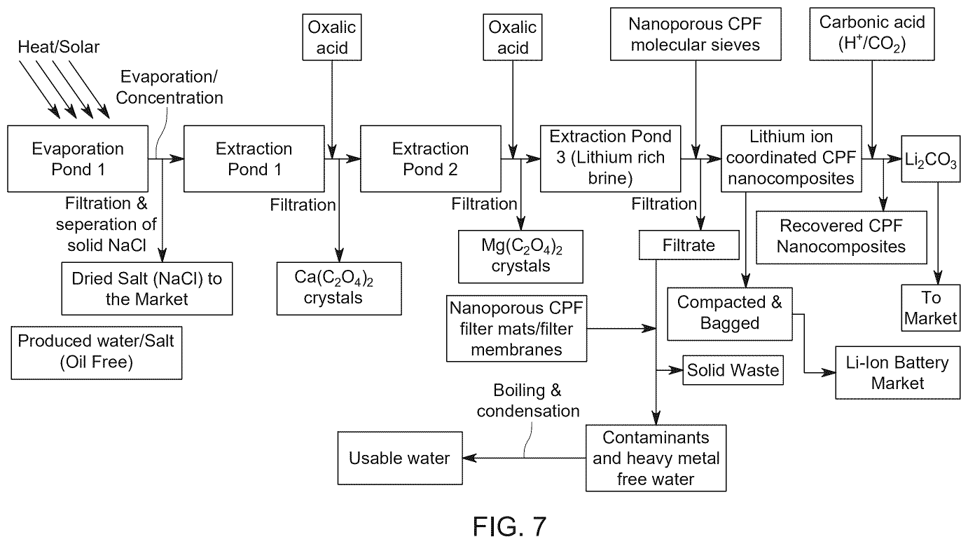

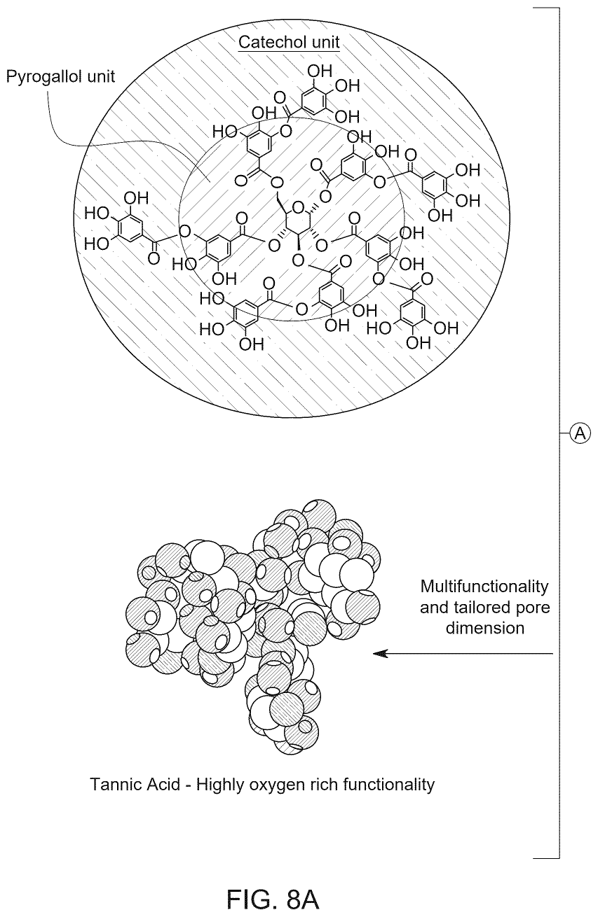

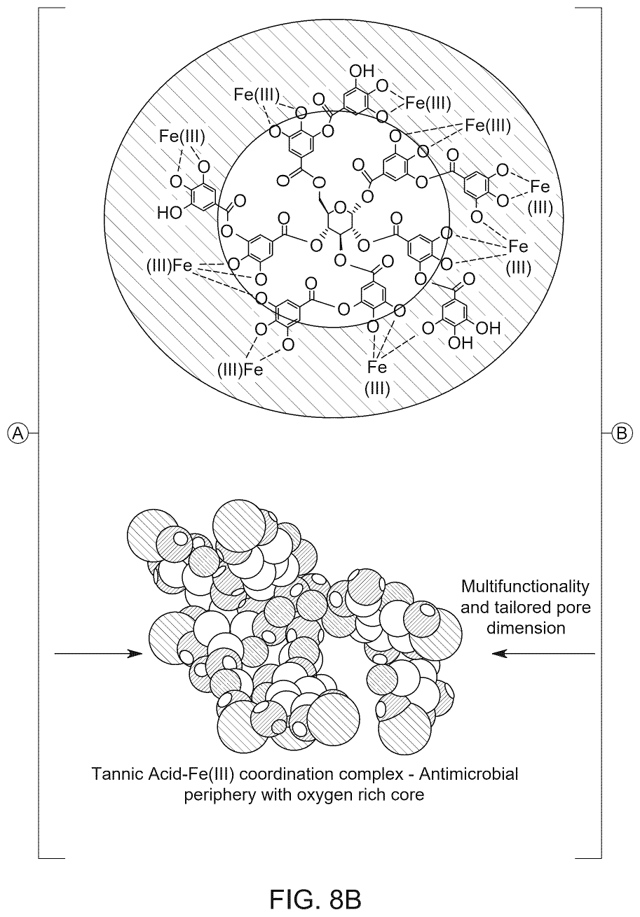

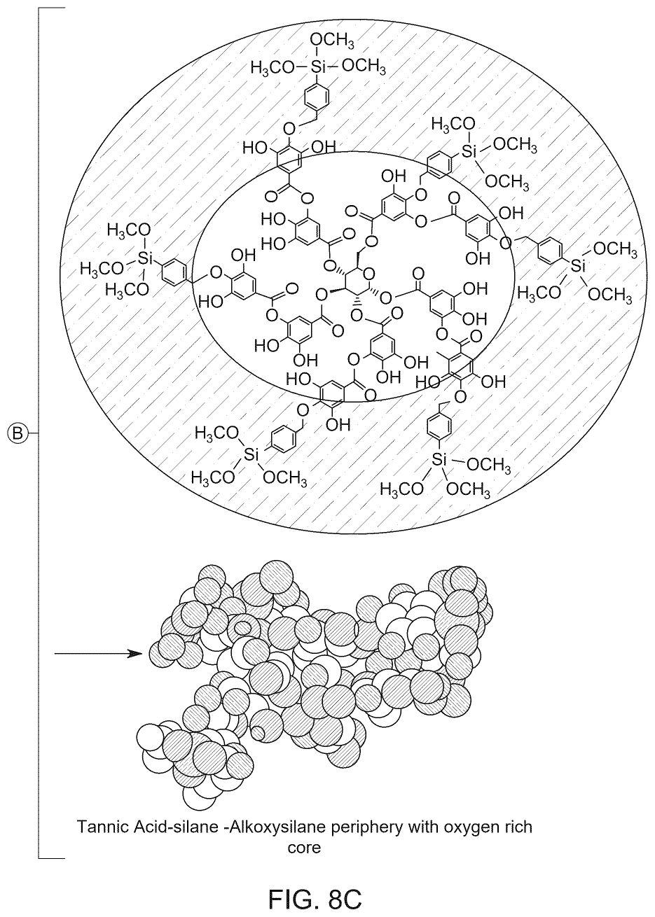

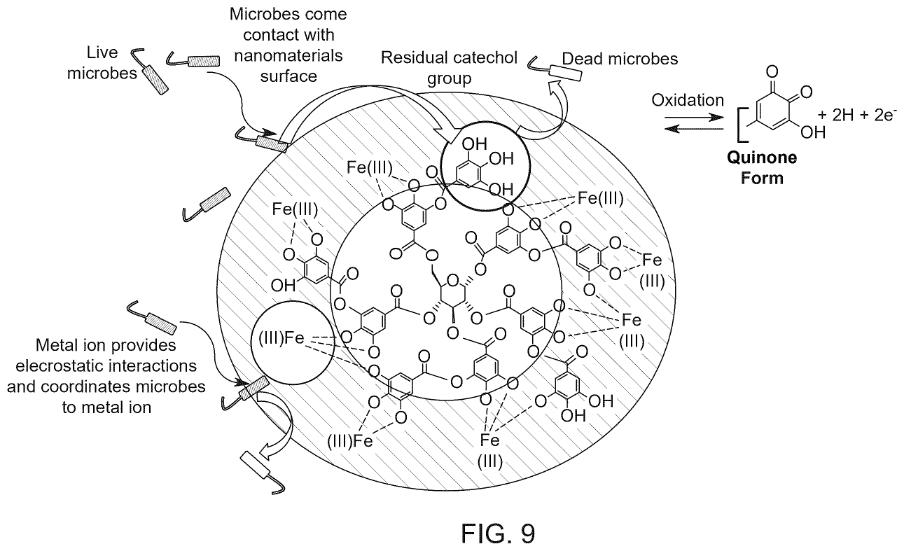

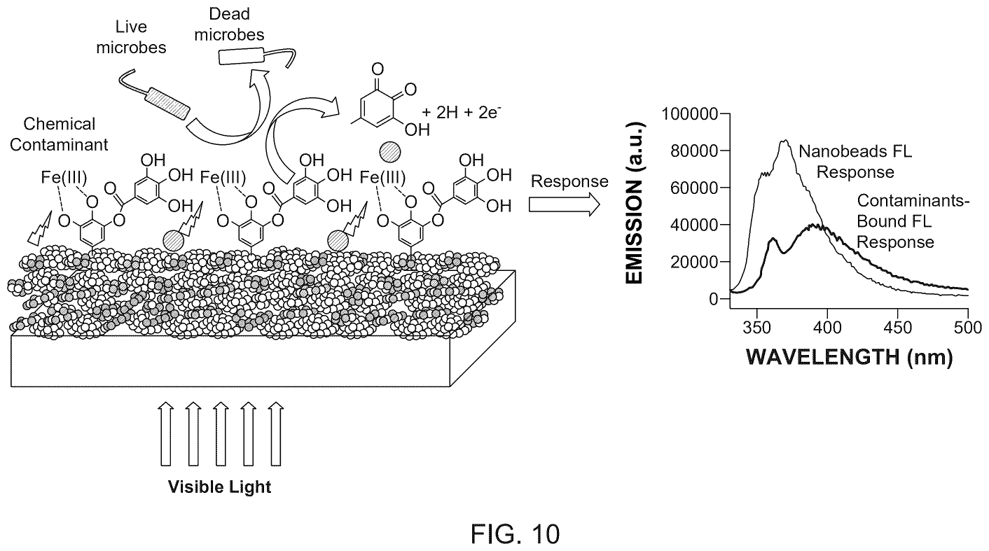

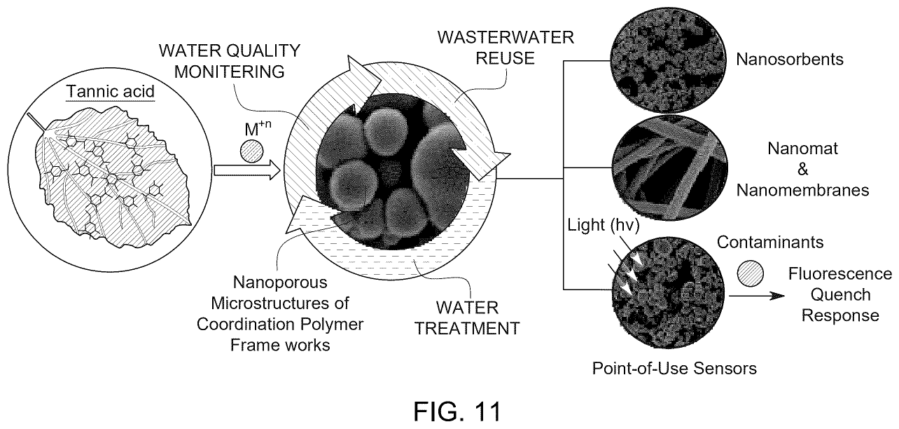

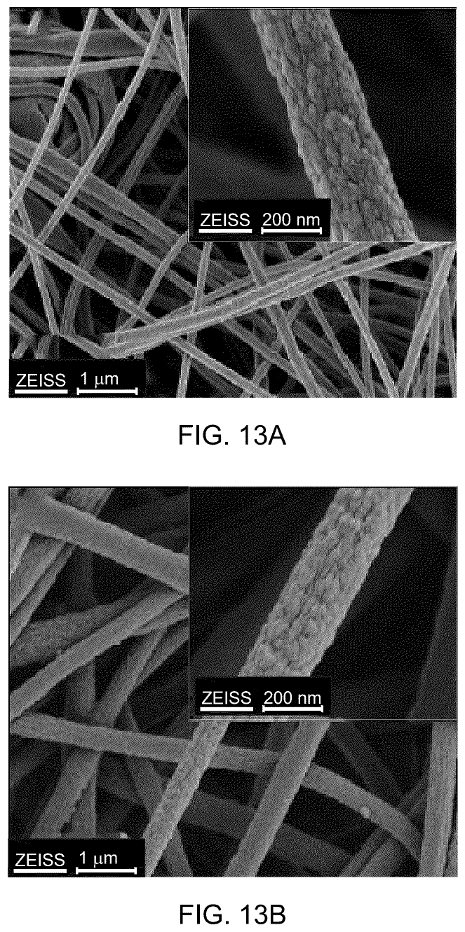

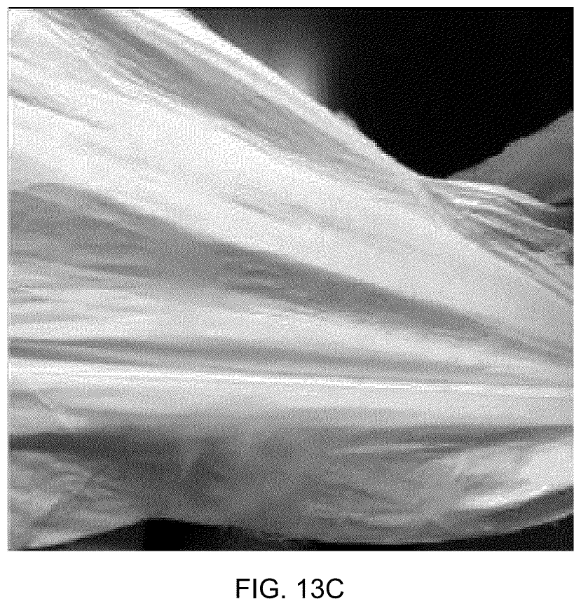

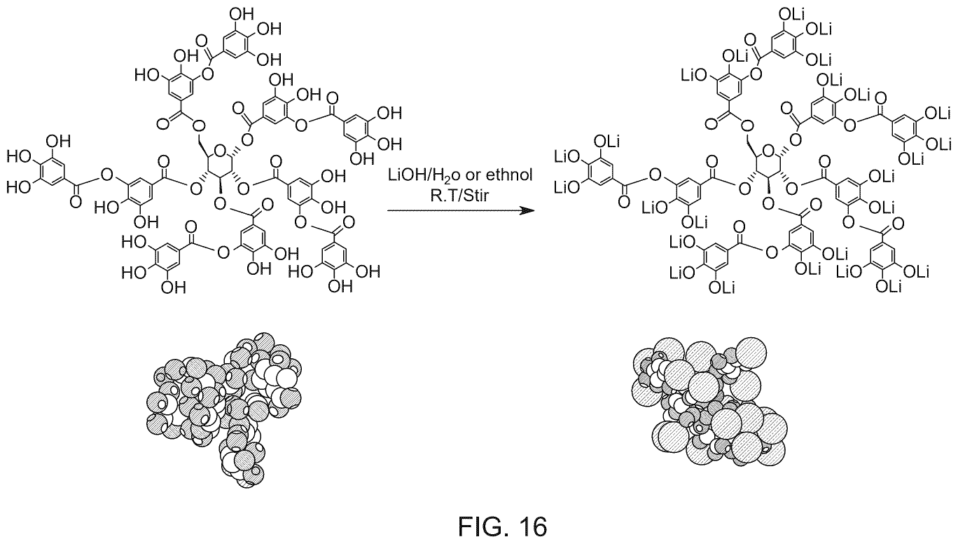

FIG. 1A is a graphical representation of a comparison of UV-vis spectral traces of TA, just after added Fe⁺³ solution, and after 1 hour of reaction time (taken during the reaction in water), and the final TA-Fe(III)-CPF (spectrum was taken after re-disperse in ethanol). FIG. 1B is a graphical representation illustrating colors of initial TA solution (before Fe⁺³ added), and after 1-hour reaction time. FIG. 2 represents scanning electron microscopy image of nanoporous beads of Fe(III)-Tannic acid CPF. FIG. 3 represents transmission electron microscopy image of nanoporous beads of Fe(III)-Tannic acid CPF. FIG. 4A illustrates the FTIR spectra of TA, TA-silane, and TA-NPs; and FIG. 4B illustrates the UV-vis spectra of TA, TA-silane, and TA-NPs. FIG. 5 represents transmission electron microscopy image of nanoporous beads of Fe(III)-Tannic acid CPF. FIG. 6 represents scanning electron microscopy image of self-assembled nanoporous microstructures of Li⁺-coordinated Tannic acid CPF. FIG. 7 represents the flowchart illustrating a lithium ion extraction process in accordance with an aspect of the present invention. FIG. 8 illustrates a materials design approach to achieve targeted structure-property functions. FIG. 9 illustrates bacterial disinfection mechanism of multi-functional TA-Fe(III) CPFs nanobeads in contaminated water. FIG. 10 illustrates a multiplex membrane as fluorescence probe. FIG. 11 illustrates an overview of the research for using CPFs for treating water. FIGS. 12A and 12B illustrate the morphologies of nanobeads of TA-Fe(III)-CPFs. FIG. 13A illustrates nanofibers of TA-Fe(III)-CPFs/poly-acrylonitrile composites; FIG. 13B illustrates nanofibers of TA-NPs/poly-acrylonitrile composites; and FIG. 13C illustrates an image of a large-area nanofiber mat. FIG. 14 illustrates Scheme 1, which represents the chemistry for the preparation of TA-Fe(III) CPFs is depicted in a first scheme. FIG. 15 illustrates Scheme 2, which represents the chemistry of preparing Tannic acid-silane and its possible chemical structure. FIG. 16 illustrates Scheme 3, which represents preparation and the possible chemical structure of Li-coordinated Tannic acid complex.

The methods described herein demonstrate the feasibility of making tannic acid silsesquioxane nanoparticles (TA-NPs) from TA-silane, utilizing the previous developed modified Stöber method by our group. TA-NPs were prepared from the direct hydrolysis and condensation of the TA-silane without silica sols as nucleation seeds. In a typical procedure of direct hydrolysis and condensation of the TA-silane without silica seeding, spherical TA-NPs were obtained by adjusting the base concentration with respect to the TA-silane precursor. A series of controlled experiments are currently conducting to adjust the reaction parameters, such as base concentration, solvent volume, and reaction time. After 24-hour reaction time, particles were collected as an off-white solid by centrifugation and repeated washing with water followed by 70% ethanol. The particles prepared in this manner show wide size distribution with average size ranging from 50 nm to 400 nm. As shown in FIG. 5, the particles are spherical and show uniformly distributed nanopores. The effect of base concentration for the particles' formation, their size distribution, and particle morphologies will be studied at a fixed silane concentration in ethanol solution. Our preliminary results support the proof-of-concept for making nanoporous TA-silsesquioxanes nanoparticles by base-catalyzed sol-gel polymerization method. This novel synthetic path offers to make functional molecular sieves that possess multiplex capabilities for extraction, heavy metal removal, and water remediation technologies.

Thus, according to at least one embodiment, the synthesis, characterization, and morphologies of tannic acid-silsesquioxane nanoparticles (TA-NPs) can include pyrogallol units of tannic acid (TA) being functionalized with a silane precursor to introduce sol-gel reactive site onto the tannic acid periphery. The sol-gel polymerization follows a hydrolysis and condensation process in the presence of a base. This results in the production of sols of nanoparticles with a silsesquioxane core structure. In various embodiments, these colloidal sols can be dispersed in aqueous-based solvents to produce coating inks for making soft dielectric thin films of nanoparticles on any flexible and irregular surfaces using, for example, various simple self-assembly driven spray coating techniques.

According to at least one embodiment, a method of synthesizing tannic acid-coordinated Fe(III)-coordination polymer frameworks (TA-Fe(III)-CPFs) comprises coordinating tannic acid (TA) with an aqueous solution of iron(III) acetate (Fe(OAc)3) to form a mixture. The method further includes subjecting the mixture to ultrasonic vibration from a sonicator, for example, for a predetermined period of time to initiate a rapid complex formation reaction. In some embodiments, other sources of ultrasonic vibrations besides a sonicator can be sued to generate the ultrasonic vibration. The method additionally includes forming tannic acid-coordinated Fe(III)-coordination polymer framework (TA-Fe(III)-CPFs) from the mixture. According to one or more embodiments, one or more steps of the method are conducted at room temperature.

According to another embodiment, a method of synthesizing tannic acid-silsesquioxane nanoparticles (TA-NPs) comprises functionalizing a pyrogallol unit within each tannic acid (TA) molecule with a silane precursor through direct hydrolysis to form a sol-gel reactive site on the TA molecule, wherein the sol-gel is formed by converting monomers into a polymer dispersed in a colloidal solution. The method further includes forming an integrated network site on a periphery of the TA molecule to generate a crude product. The method also includes concentrating the crude product by subjecting it to a vacuum, and washing the concentrated crude product with hexane, for example, to create a refined product; other suitable chemicals can also be used for washing the concentrated crude product. The method furthermore includes treating the refined product with de-ionized water, for example, to remove unreacted TA to yield tannic acid-silsesquioxane nanoparticles (TA-NPs). According to one or more embodiments, one or more steps of the method are conducted at room temperature.

According to one embodiment, a method of extracting metal ions from an aqueous solution comprises providing a molecular sieving coordination polymer framework (CPF) material derived from tannin or tannic acid (TA), and passing a liquid substance through the molecular sieving CPF material to extract metal ions present in the liquid substance. According to one or more embodiments, one or more steps of the method are conducted at room temperature.

According to one embodiment, a method for extracting lithium from lithium-bearing salt brine comprises passing lithium-bearing salt brine through a filter comprising a nanoporous molecular sieving coordination polymer framework (CPF) material to extract lithium ions present in the lithium-bearing salt brine. The method further can further include causing the lithium ions to react with the nanoporous molecular sieving coordination polymer framework (CPF) material to form a lithium ion coordinated CPF nanocomposite material. The method can furthermore include capturing the filtrate residue after removing the lithium ion coordinated CPF nanocomposite material. According to one or more embodiments, one or more steps of the method are conducted at room temperature.

According to at least one embodiment, as depicted in Scheme 2 (see FIG. 15), sol-gel reactive sites are introduced randomly onto tannic acid (TA) backbone upon alkylating hydroxy groups of phenol units of the TA molecule with an organosilane precursor using Williamson ether synthesis to thereby produce a TA-silane precursor.

As is well-known to a person of skill in the art, the Williamson ether synthesis is an organic reaction that involves forming an ether from an organohalide and a deprotonated alcohol (alkoxide). This reaction was developed by Alexander Williamson in 1850. Typically it involves the reaction of an alkoxide ion with a primary alkyl halide via an S_{N}2 reaction. The Williamson reaction is of broad scope, is widely used in both laboratory and industrial synthesis, and remains the simplest and most popular method of preparing ethers. Both symmetrical and asymmetrical ethers are easily prepared. The intramolecular reaction of halohydrins in particular, gives epoxides. In the case of asymmetrical ethers there are two possibilities for the choice of reactants, and one is usually preferable either on the basis of availability or reactivity. The Williamson reaction is also frequently used to prepare an ether indirectly from two alcohols. One of the alcohols is first converted to a leaving group (usually tosylate), then the two are reacted together. The alkoxide (or aryloxide) may be primary, secondary or tertiary. The alkylating agent, on the other hand is most preferably primary. Secondary alkylating agents also react, but tertiary ones are usually too prone to side reactions to be of practical use. The leaving group is most often a halide or a sulfonate ester synthesized for the purpose of the reaction. Since the conditions of the reaction are rather forcing, protecting groups are often used to pacify other parts of the reacting molecules (e.g. other alcohols, amines, etc.)

According to at least one embodiment, the crude product concentrated under vacuum is further purified by washing with hexane, followed by washing with de-ionized water to remove unreacted tannic acid (TA) and other products. Although there is a tendency to hydrolyze methoxy groups of silane units to stretch during the washing with de-ionized water, the FTIR analysis shows that there is no noticeable broad IR (infra-red) stretching at 3000 cm⁻¹ to 3500 cm⁻¹ for hydroxyl groups (FIG. 4(a)). FTIR spectrum of the TA-silane (FIG. 4A) also confirms the presence of characteristics bands for Si—O (1120-1025 cm⁻¹) and Si—C (1207 cm⁻¹). The ester carbonyls and aromatic C—C (carbon-to-carbon) stretching vibrations are observed at 1692 cm⁻¹ and 1602 cm⁻¹-1511 cm⁻¹ respectively. The carbonyl stretching of silane is found to be lower than the ester carbonyls stretching of tannic acid (TA). This further confirms the silane functionalization. TGA analyses reveal that TA-silane is thermally stable up to 425° C. with an initial mass loss of ˜15% by 400° C., whereas TA is thermally stable up to 525° C. with an initial mass loss of 15% at 400° C. In both cases, the initial mass loss could be due to the traces of impurities including oligomer fractions and solvent molecules. However, the decomposition temperature of TA-silane decreases by ˜100° C. and this reflects low thermal stability of TA-silane relative to the thermal stability of TA. The unfunctionalized TA shows total organic mass loss of 96% at 600° C. whereas the total organic mass loss of TA-silane is 83% at 475° C. The decrease in mass loss results from the decomposition of the total organic content compared to its original polymer whereas the higher residual weight results from the inorganic content of the TA-silane; these observations further indicate the incorporation of silane units onto the polymer backbone.

According to at least one embodiment, the UV-vis absorption spectrum is collected in ethanol and compared with the absorption spectrum of TA. Typically, the absorption spectrum of tannic acid (TA) exhibits two absorption maxima at 212 nm and 277 nm with a weak shoulder peak at 240 nm. When compared with TA absorption, in the TA-silane's absorption spectrum, the absorption maxima at 212 nm disappears and shows enhanced absorption at 246 nm, which is little red shifted to the shoulder peak of TA at 240 nm. It is to be noted that the original TA absorption at 277 nm is less pronounced. The additional absorption peak at 344 nm in TA-silane confirms the functionalization of pyrogallol hydroxy groups with benzyl units of organoalkoxysilanes.

According to at least one embodiment, tannic acid silsesquioxane nanoparticles (TA-NPs) are synthesized from TA-silane utilizing the modified Stöber method. TA-NPs can accordingly be synthesized from the direct hydrolysis and condensation of the TA-silane without nucleation seeds of silica sols. In a typical procedure of direct hydrolysis and condensation of theta-silane without silica seeding, spherical TA-NPs are obtained by adjusting the base concentration with respect to the TA-silane precursor. A series of controlled experiments can be conducted to adjust the reaction parameters—such as base concentration, solvent volume, and reaction time. After 24 hours of reaction time, particles are collected as an off-white solid substance by centrifugation. The resulting solid substance is subjected to repeated washing with water, followed by washing with 70% ethanol. According to at least one embodiment, the particles prepared in this manner show wide size distribution with average size ranging from 50 nm to 400 nm. As shown in FIGS. 5A-5E, the particles are spherical and show uniformly distributed nanopores. The effect of base concentration for the formation of particles, their size distribution, and particle morphologies can be studied at a fixed concentration of silane in ethanol solution.

Embodiments of the presently disclosed subject matter can also be used for low-cost wastewater treatment and reuse processes. Embodiments of the presently disclosed subject matter can provide an innovative nanotechnology-enabled simple, rapid, and low-cost wastewater treatment and reuse process, utilizing natural polyphenol-based novel hierarchical microstructures of coordination polymer frameworks (CPFs). The CPFs' ability to control the functionality, pore dimension, and selectivity at molecular level can enable the utility and versality of CPFs as molecular sieves for fast and efficient water purification and reuse of produced water from non-traditional water resources. CPFs can be used in the development of nanoporous sorbents, liners, membranes, filter mats, and point-of-use fluorescent probe for multiplex detection of heavy metal ions and contaminants, with selective extraction and removal as well as water disinfection and decontamination in a rapid and simple manner. Embodiments of the presently disclosed subject matter can help provide an efficient and cost-effective service to wastewater treatment plants, water purification sectors, produced water processors and haulers. Since various embodiments of the presently disclosed subject matter can utilize agricultural and forest origin products-based high value-added environmentally friendly nanomaterials, water treatment and reuse process that include the presently disclosed subject matter can overcome high costs, challenges in scalability, as well as potential environmental and health risks associated with current nano-based water purification nanomaterials.

The demand for fresh water is growing exponentially, in particular for food production, as 70% of the world's freshwater withdrawals are already accounted for agricultural irrigation. Current technologies are reaching their limits in meeting increasingly stringent water quality standards and dealing with emerging contaminants such as pharmaceuticals, personal care products, and viruses. Existing wastewater collection and water supply systems are not designed to accommodate the increased needs. Centralized treatment and distribution systems allow little flexibility in response to the demand for water quality or quantity and are no longer the solution to a sustainable urban water supply. Rapid population growth, which is predicted to increase to 3 billion by 2025, puts 700 million people below the water stress threshold of 1700 m³ per person per year. As cost, scalability, environmental safety, and clean water are becoming key drivers for advancing future water treatment and quality control technologies, developing low-cost, environmentally benign, and safe innovative nano-based water treatment technologies are necessary.

Embodiments of the presently disclosed subject matter can provide nanotechnology-enabled water remediation technologies. Adapting highly advanced nanotechnology as described herein to traditional engineering processes can advantageously offer new opportunities in technological developments for advanced water and wastewater technology processes. Nanoengineered materials as described herein can provide great potential for water purification, treatment, and reuse technologies, in particular for decentralized treatment systems, point-of-use devices, and heavily degradable contaminants.

The nanomaterials' extraordinary properties, such as high surface area, photosensitivity, catalytic and antimicrobial activity, electrochemical, optical, and magnetic properties, and tunable pore size and surface chemistry, provide useful features for water treatment applications. Applications of various embodiments of the presently disclosed subject matter can further include sensors for water quality monitoring, adsorbents, high-performance membranes, and disinfection and decontamination processes that can harvest solar energy in parallel. The modular, multifunctional and high-efficiency processes, enabled by nanotechnology can provide a route to retrofit aging infrastructure and to develop high performance, low maintenance decentralized treatment systems, including point-of-use devices. One of the most important advantages of nanomaterials as disclosed herein, when compared with conventional water technologies, is their ability to integrate various properties, resulting in multifunctional systems such as nanocomposite membranes that enable both particle retention and elimination of contaminants. Nanomaterials fabricated by methods disclosed herein can advantageously enable higher process efficiency due to high-density functionality and higher surface area.

Nanomaterials for variety of water remediation processes have been demonstrated at lab stage. For example, carbon nanotubes (CNTs) can operate as nanoadsorbents (as substitutes to activated carbon) since they effectively remove both organic and metal contaminants. The available binding sites and non-covalent interactions between contaminant-CNTs control organic contaminant adsorption on CNTs are advantageous. Binding sites on CNTs are more available than those on activated carbon, which contains inaccessible pores, especially for bulky molecules such as tetracycline. The π-electrons rich surface of CNTs can serve as an electron donor or as an electron acceptor for many polar aromatics such as nitroaromatics and phenols. While hydrophobic graphitic surfaces are the main sites for organic adsorption, metal ions adsorb primarily on surface functional groups, which can be reversed by pH adjustment, enabling reuse. The fibrous structure, antibacterial activity, and conductivity of CNTs enable their use in antimicrobial filters. The antibacterial mechanism of CNTs and some other carbon-based nanomaterials was proposed to involve membrane perturbation and electronic structure-dependent oxidation stress. Short, dispersed, and metallic CNTs with small diameters are more toxic. CNT filters fabricated using methods described herein can also be used in electrochemical processes, in which a small intermittent voltage inactivates physically trapped microorganisms through oxidation. The electric potential results in electrophoresis of viruses toward CNTs, alleviating the negative impact of natural organic matter on virus retention by the CNT filter. Fullerenes and CNTs are also photosensitive and can generate reactive oxygen species in water. When activated by visible light, amino-fullerenes and fullerol produce singlet oxygen (102), which has high selectivity toward contaminants containing electron-rich moieties, allowing their degradation in water with less interference from background organics (e.g., wastewater). Nonetheless, the high cost of CNTs limits the commercial applicability of the CNT technology.

Nanomagnetite materials possess unique superparamagnetic properties, allowing heavy metal separation from water in a weak magnetic field. Such magnetic properties can enable a new class of core-shell structure nanoparticles where the shell provides desired functionality and the magnetic core allows easy particle separation. Core-shell nanomaterials can consist of a shell chemically tailored for rapid, selective adsorption and a reactive core for degradation of adsorbed contaminants. Specialty nanoadsorbents have also been designed using dendrimers with specific binding sites. Advancements in sensor development have evidenced that effective integration of nanomaterials and recognition agents (e.g., antibodies, aptamers, carbohydrates, and antimicrobial peptides) can yield fast, sensitive, and selective sensors for microbial detection. Nanomaterials can also be utilized to improve sensor sensitivity and speed and achieve multiplex target detection owing to their unique electrochemical, optical, or magnetic properties. For example, magnetic nanoparticles and CNTs can be used for sample concentration and purification. Quantum dots (QDs), dye-doped nanoparticles, noble metal nanoparticles, and CNTs are widely used in nanosensor research. QDs have wide absorption bands but narrow and stable fluorescent emission spectra that vary with particle size and chemical composition, allowing multiplex target detection with one excitation source. Dye-doped silica and polymeric nanoparticles exhibit high luminescent intensity, as large numbers of dye molecules are confined to each nanoparticle. Nobel metal nanomaterials also improve surface enhanced Raman spectroscopy, achieving enhancement factors up to 10 and single molecule detection. CNTs are excellent materials for electrodes and field-effect transistors. Several nanomaterials have strong antimicrobial properties, including nano-Ag, nano-ZnO, nano-TiO₂, nano-Ce₂O₄, CNTs, and fullerenes. These nanomaterials inactivate microorganisms by releasing toxic metal ions (e.g., Ag⁺ and Zn²⁺), compromising cell membrane integrity upon direct contact (e.g., CNTs, nC60, nano-Ce₂O₄) or generating reactive oxygen species (e.g., nano-TiO₂, fullerol, and aminofullerene) with fewer tendencies to form disinfection by products. Among them, nano-Ag is a common choice for point-of-use water treatment devices because of its strong and wide-spectrum antimicrobial activity and low toxicity to humans.

Embodiments as described herein accordingly provide for fabricating novel tannic acid-based coordination polymer frameworks (CPFs) for use in water purification and remediation applications. Embodiments as described can provide for using highly nanoporous filters, mats, and membranes of tannic acid based CPFs for water purification and remediation. Utilizing tannic acid (TA) as the core material, Embodiments as described herein can provide a series of novel tannic acid-iron coordinated complexes' nanomaterials, TA-Fe(III)-CPFs and tannic acid silsesquioxane nanoparticles, TA-NPs.

Coordination polymer frameworks (CFPs) provide highly porous and high-density functionality for rational design of high surface area platforms with selectivity and tailored pore environment to serve as molecular sieves. Coordination polymers (CPs) and their sub-class, metal-organic frameworks (MOFs) are highly porous self-assembled nanostructures with high surface area and defined pore dimensions. The CPFs precisely position metal-based nodes by connecting with functional, organic ligands via coordination bonds. Compared with traditional porous solids, such as zeolites, activated carbon and mesoporous silica, CPFs allow for designing the framework structure and tailoring pore environments at the molecular. Their size, shape, and self-assembly can be carefully controlled via an effective covalent synthesis method to yield three-dimensional (3-D) hierarchical architectures. These nanoscale building blocks and their assemblies combine the flexibility, functionality, transparency, and ease of processability of soft matter (organic) with the electrical, thermal, and mechanical properties of hard matter (inorganic). CPFs accordingly offer a new window for fine-tuning structural nodes with known geometries and coordination environments. Their porous structures and the geometric arrangement of inorganic and organic components enable rational design for high-surface area platforms.

The CPFs' application as adsorbents for water remediation thus far has been scarce mainly due to the poor stability of current synthetic MOFs in water media. With the synthetic strategies implementation to make water stable MOFs, the number of MOFs demonstrated in water remediation are mainly limited to six high-cost representative MOFs-MIL-53(Fe), MIL-101(Fe), UIO-66(Zr), IRMOF-3(Zn), MOF-5(Zn) and ZIF-8(Zn), with large scale production not being practical. Thus, developing novel families of water-stable CPFs in large scale for a low-cost is necessary for the potential application in the field.

The modified sol-gel method as described herein can be advantageous for creating biodegradable, non-toxic, environmentally benign nanoporous nanoparticles with silsesquioxane core structure. Thus, the significance of the embodiments of the presently disclosed subject matter can open up a new perspective in the synthetic advancement for creating functional nanoporous, natural polyphenol-based molecular sieves, derived from agricultural and forest origins products.

The inventors explored utilization of naturally abundant and environmentally friendly novel class of coordination polymer frameworks for water treatment technologies. According to various embodiments of the presently disclosed subject matter, a series of novel coordination polymer frameworks (CPFs) using a natural polyphenol, Tannic Acid (TA) are designed, synthesized, and explored for nanotechnology-enabled wastewater treatment and reuse processes. Owing to tannic acid's rich oxygen binding sites and its ability to form metal ion-chelated coordination network, the research by the inventors focused on novel materials design strategies, their preparation, self-assembly processes to make hierarchical CPFs, and use them as nanofilters, nanomembranes, nanosorbent, and nanomats. Introduction of sol-gel reactive sites onto polyphenol backbone that yields silsesquioxane framework provides additional materials stability, porosity, and selective functionality to the tannic acid's coordination polymer framework. These hierarchical microstructures possess molecular sieving ability, tailorable pore size, and functional coordination sites, providing high binding affinity for organic and inorganic contaminants and microbes.

According to at least one embodiment, a natural polyphenol based-CPF was synthesized through a rapid and scalable synthesis method, developed to make metal-coordinated tannic acid complex, Fe(III)-TA CPFs, nanoporous beads. This low-cost scalable synthesis method, combined with supramolecular chemistry principles, presents possibilities for manipulating tannic acid-based CPF's function and porosity at nanoscale to coordinate specific metal ions, including smallest metal ions (lithium ions), providing potential for lithium ion extraction from brines and converting into either pure lithium carbonate or used lithium coordinated CPF composites for lithium ion batteries. Accordingly, in some embodiments, the lithium is recovered as lithium carbonate and/or lithium ion coordinated CPF. Embodiments described herein provide for a series of novel molecular sieving CPFs-derived from natural abundant tannic acid present in plants.

Embodiments of the presently disclosed subject matter can advantageously provide for: (1) reducing the use of freshwater and improve agricultural resilience/sustainability by innovative approaches, tools and technologies that permit irrigation with nontraditional water resources; (2) novel uses and high value-added products of nano-biomaterials from agricultural and forest origins for food and non-food applications; (3) nanotechnology-enabled smart sensors for accurate, reliable and cost-effective early and rapid detection of contaminants in water; and, (4) discovery and characterization of nanoscale phenomena, processes, and structures relevant and important to agriculture and food.

Various embodiments of the subject matter as disclosed herein can further provide for: (1) discovery and characterization of natural polyphenol-based nanoscale structures; (2) development of nano-based simple, rapid, and low-cost wastewater treatment and reuse systems; and, (3) fabrication of portable, field-deployable and agriculturally affordable sensors for water quality monitoring, contaminants detection, and disinfection.

Embodiments of the presently disclosed subject matter can further provide for advancing potential environmentally benign and low-cost nano-based technologies for wastewater treatment, reuse, and point-of-use sensors. Embodiments of the presently disclosed subject matter can also enable sustaining agricultural resilience by reducing freshwater demand, enhancing water quality, affordability, and safety while increasing protection for natural resources, the environment, and agricultural ecosystems. Embodiments of the presently disclosed subject matter can be advantageously applied to fabricating the novel coordination polymer frameworks as disclosed herein in the form of molecular sieves, filters, membranes, and sensing materials for developing water treatment technologies.

According to various embodiments, building on the synthesis of coordination polymer frameworks (CPFs) and metal organic frameworks (MOFs), it is possible to prepare a variety of transition metal ions (Fe⁺³, Zn⁺², and Ni⁺²) coordinated TA-CPFs and multifunctional TA-based silsesquioxane nanoparticles (TA-NPs) with tailored pore dimension and particle size. Developing novel high-value biodegradable nanomaterials will establish structure-property relationship that enable the introduction of extrinsic porosity to polyphenol framework and the silsesquioxane core structure, providing high density functionality for contaminants-scavenging and disinfection.

The applicability of TA-CPFs as nano-adsorbents is advantageous since TA-CPFs' binding affinities to common threat of heavy metal ions, such as Pb⁺², Hg⁺², Cd⁺², and As⁺³ can provide for heavy metal extraction from produced water samples. Antimicrobial effect of TA-transition metal ion coordinated-CPFs can be used for water disinfection and decontamination technologies. Incorporating TA-CPFs into polyacrylonitrile (PAN) and polyvinylidene difluoride (PVDF), which are most common commercial filter membranes, to fabricate highly porous and multi-functional CPFs-based nanomats, filters, and membranes can be fabricated via electrospinning method. These filters can be advantageously used for water purification process from non-traditional water resources.

The materials fabricated using the methods disclosed herein can be used as fluorescence sensors at one excitation wavelength for contaminants detection and water quality monitoring. The materials as disclosed herein can form part of a smart sensor that provides for fast and accurate detection of chemical and pathogens. Fluorescence signal received from polyphenol units in tannic acid combined with the long-range wavelength emission from transition metal ion centers can serve as a unique platform whereby these materials can be used as sensing membranes to detect analytes on-site without requiring additional laboratory analyses.

The deployment of coordination polymer frameworks in wastewater treatment and reuse depends on their internal surfaces with high densities of strong adsorption/binding sites, functional groups, and tailorable pore dimensions. Combining tannic acid with silsesquioxane core structure and coordinating with biocompatible transition metal ions (as shown, for example, in FIG. 8) can supply unique chemical, morphological, and physical properties, providing multiplex capabilities to serve as efficient, environmentally benign, and low-cost molecular sieves for water treatment.

Utilizing the syntheses described herein, in one embodiment, three different metal ions (Fe⁺³, Zn⁺², and Ni⁺²) coordinated TA-CPFs nanostructures and multifunctional tannic acid-silsesquioxane nanoparticles (TA-NPs) can be developed. These three metals are selected due to their individual inherent properties of antimicrobial, optical, and magnetic behavior as well as biocompatibility, enabling a significant potential for eco-friendly water treatment technologies. Experimental conditions and physical parameters that govern the formation self-assembled microstructures and nanoparticles, and theoretical prediction of coordination complex formation through computational analysis can lead to the development a robust and reproducible synthesis approach that could be widely used for making bio-nanomaterials from other natural polyphenols and their derivatives.

Oxygen rich tannic acid's five pyrogallol and five catechol groups can provide coordination bonding sites to metal ion, while providing diverse interactions, including hydrogen bonds, π-π interactions, and hydrophobic interactions to form self-assembled hierarchical structures of coordination polymer frameworks. Computational analyses reveal the most probable binding sites of tannic acid's catechol and pyrogallol units to a selected metal ion and provide insight to its optical behavior, and enhanced chemical, structural, and physical properties, including binding energies with respect to different metal ions. Density functional theory calculations can be utilized to assess the feasibility of binding metal ions to tannic acid active sites. Since the coordination polymer framework is excessively larger (self-assembled units of coordination complex), DFT (density functional theory) analysis can be applied to monomeric coordination complex unit. The geometry optimized structure of the coordination complex can be obtained along with the electron potential distribution map to understand the available functional binding sites in the complex for contaminants' scavenging.

According to one embodiment, all electronic structure calculations are performed using a Gaussian 09 package and their output files analyzed using Gauss View05 software. First, the molecular geometry of tannic acid is optimized using the B3LYP functional and the split-valence 6-31G basis set. Geometries can be re-optimized using the same approach, but with placing multiple metal ions in multiple different locations around the catechol and pyrogallol units. The same method can be used but this time with a mixed basis set, applying the LANL2DZ pseudo-potential (LANL stands for Los Alamos National Laboratory)) to metal ion and 6-31G for all other atoms. According to one embodiment, alternative calculations can be employed, including ethanol as an implicit solvent, but there will be no change in the ordering or relative energy differences between positions nor the optimized positions of metal ions and thus will not be included in further calculations. A more diffuse basis set (6-31+G) can also be applied to inspect the effect of metal ion positions taking into account the outer reaches of the atomic radii. Binding energies can be calculated and compared with respect to different metal ion coordination complexes from the energies of optimized geometries for before complex formation and after complex formation scenarios.

According to one embodiment, utilizing the synthesis procedure developed in the preliminary work demonstrated for preparation of TA-Fe(III) CPFs in synthetic Scheme 1, Ni⁺² and Zn⁺² metal ion coordinated tannic acid CPFs are prepared. The reaction parameters are optimized, and complex formation are monitored by collecting UV-visible spectral traces. According to one embodiment, self-assembled microstructures of these metal ion coordinated CPFs are fully characterized using FTIR, UV-visible spectroscopy, fluorescence spectroscopy, proton NMR, X-ray photoelectron spectroscopy (XPS), and powder XRD. According to one embodiment, elemental mapping conducted from STEM/EDS using TEM provides the transition metal ion coordination distribution. Morphologies are visualized using SEM and TEM. Thermal stability of nanostructures is evaluated via thermogravimetric analysis. According to one embodiment, the porosity and surface area of microstructures are analyzed from nitrogen gas sorption isotherm at 77 K.

According to some embodiments, a sol-gel polymerization method is used to demonstrate the feasibility of making TA-silsesquioxanes nanoparticles from its silane precursor (see Scheme 2 illustrated in FIG. 15). Upon randomly functionalizing tannic acid's catechol hydroxy groups with para-(chloromethyl)-phenylethyltrimethoxy silane, a novel sol-gel reactive sites functionalized TA-silane precursor is prepared. The base-catalyzed hydrolysis and condensation of the TA-silane precursor, yields spherical, raspberry-like TA-silsesquioxane nanoparticles (TA-NPs) in considerably good yield. According to one embodiment, in order to prepare series of different size range particles with tailored porosity, a series of controlled experiments are conducted to adjust the reaction parameters, such as base concentration, solvent volume, and reaction time. The effect of base concentration for the formation of particles, their size distribution, and particle morphologies are studied at a fixed silane concentration in ethanol solution. All necessary characterizations are conducted to evaluate the particle composition, crystallinity, thermal stability, surface area and pore distribution, and optical properties.

The range of materials that can be fabricated in this fashion is extremely diverse due to the capability of incorporating a wide range of ligand compositions, from reactive functional groups to fluorescent molecules. Moreover, this method can provide opportunities to introduce more organic properties into an inorganic matrix. Increasing the organic content could result in a retained 3-D architecture in a homogeneous solution rather than nanoparticle aggregation observed in typical surface functionalized Stöber silica particles. The organic functional groups of these hybrid particles can fulfill two functions: (1) modification of the inorganic core, and (2) improving compatibility with a host matrix. Chemically tailoring ligands using this method can also expand the scope of grafting/ligand chemistry to other applications, including the natural polyphenol-based organic-inorganic hybrids.

Nanoadsorbents offer significant improvements over conventional adsorbents with their extremely high specific surface area, short intraparticle diffusion distance, and tunable pore size and surface chemistry. High specific surface area provides high adsorption capacity. Moreover, the high surface energy and size dependent surface structure with high density functionality at the nanoscale may create highly active adsorption sites, resulting in higher surface-area-normalized adsorption capacity. Structure-property relationship along with in-depth analysis of particle morphologies and their porosity distribution can provide the foundation to investigate their potential to use as nanoadsorbents for heavy metals and organic contaminants scavenging and water disinfection. The novel nanomaterials described herein possess high nanoporosity and oxygen rich binding sites, possessing properties of an ideal nanoadsorbent for rapid and efficient water treatment technologies. Tailored pore dimension, oxygen rich high density multifunctionality, and coordinated transition metal ion nodes in TA-CPFs can provide a new technology platform to selectively target a wide array of trace contaminants and microbes in wastewater.

According to one embodiment, TA-M⁺ⁿ-CPFs and TA-NPs nanobeads are tested for removal of four selected heavy metal ions-Pb⁺², Hg⁺², Cd⁺², and As⁺³. According to one embodiment, nanomaterials are tested with respect to individual heavy metal ion extraction in solutions, and then resulted heavy metal ions solution can be analyzed. Experiments are conducted to investigate the influences of contact time, initial pH, K⁺ and Na⁺ concentrations, co-existing polyvalent metal ions and adsorption-desorption cycles on the sorption process. In pH dependent studies, batch absorption experiments are carried out and the heavy metal ions' concentrations after absorbents removed are quantified by LC-MS spectroscopy. Adsorbent can also be analyzed by XPS and STEM/EDS to quantify the atomic percentage of absorbed heavy metal ions. Adsorption-desorption recycle experiments can also be carried out simultaneously. According to one embodiment, the heavy metal ion adsorption and desorption mechanisms are investigated using sorption kinetic plots and sorption isotherms. The sorption kinetics are determined at a pre-determined concentration at a pre-determined pH. The pseudo-first order and pseudo-second order kinetics models, which are shown in Equations (1) and (2), are applied to study the specific kinetic parameters of heavy meatal ions adsorbed onto TA-CPFs.

$$\begin{matrix}ln ( {q}_{e} - {q}_{i} ) = ln {q}_{e} - {k}_{1} t & ( 1 ) \\ \frac{t}{{q}_{i}} = \frac{1}{{k}_{2} {q}_{e}^{2}} + \frac{t}{{q}_{e}} & ( 2 )\end{matrix}$$

Where qₑ(mg/g) is the adsorption capacity at equilibrium; k₁ (min⁻¹) and k₂ (g/(mg min)) represent the rate constants of the pseudo-first order and pseudo-second order adsorption, respectively. The values of k₁ and k₂ can be determined by the slope and intercept of the kinetic isotherm lines.

According to one embodiment, the sorption isotherm of individual heavy metal ions on TA-CPFs are measured by increasing the heavy metal ion concentration from 20 mg/L to 300 mg/L at 298 K and the optimized pH value, which is determined by initial studies. To study the adsorption behavior between the heavy metal ion and TA-CPFs, Langmuir and Freundlich are used to analyze the equilibrium adsorption data. Linear equations of Langmuir and Freundlich models are shown in Equations (3) and (4).

$$\begin{matrix}\frac{{C}_{e}}{{q}_{e}} = \frac{1}{{q}_{m} {K}_{L}} + \frac{{C}_{e}}{{q}_{m}} & ( 3 ) \\ ln {q}_{e} = ln {K}_{F} + \frac{1}{n} ln {C}_{e} & ( 4 )\end{matrix}$$

where qₘ(mg/g) and K_{L} are the maximum adsorption capacity for fitting and a constant related to the free energy of adsorption, respectively. Kr and n are the constants for Freudlich model.

According to one embodiment, selectivity over common organics or inorganics, such as Ca²⁺, Mg²⁺, Na⁺, and K⁺, found at high concentrations in wastewater or surface water samples, respectively, is the an important factor when evaluating a porous material for water treatment applications. While ions can compete for binding sites, organics can complex metals in solution or block the pores of the adsorbent entirely compromising capacity and/or removal rate. All four types of functional nanomaterials can be tested for selected water samples with high concentrations of Hg²⁺ and Pb²⁺.

According to one embodiment, utilizing the antimicrobial and antioxidant properties of tannic acid and three transition metal ions, herein, the effectiveness of these novel nanomaterials towards disinfecting bacteria contaminated water are easily evaluated. This evaluation confirms that TA-CPFs based nanomaterials can be used for developing a point-of-use disinfection device for rapid and efficient detection of microbes in water. Testing TA-M⁺ⁿ CPFs materials' capability for inactivating >99% of both Gram-negative and Gram-positive bacteria including Escherichia coli, Vibrio cholerae and (methicillin-resistant) Staphylococcus aureus within rapid treatment time can be done. For this, TA-M⁺ⁿ CPFs and TA-NPs nanobeads are coated onto glass petri dish and bacteria-contaminated water added to the dishes and incubated for a pre-determined time-period. According to one embodiment, the amounts of viable bacteria that remain in the bulk water after treatment, denoted as ‘treated’ water, are determined via standard colony forming units (CFU) analysis and compared to the untreated sample (i.e., the negative control). It is noteworthy that these bacteria (e.g., E. coli and V. cholerae) are selected on the basis that they are some of the most common bacteria found in contaminated water supply. In addition, methicillin-resistant S. aureus (MRSA) can be studied as well to ascertain the ability of nanomaterials to combat antibiotic-resistant strains. An additional experiment is performed to determine if TA-CPFs are feasible in a large-scale operation.

The antimicrobial mechanism for transition metal ion coordinated TA-CPFs is illustrated in FIG. 9. It is believed that bacteria are first adsorbed onto the nanomaterial surface, followed by subsequent inactivation by the catechol groups and transition metal ion nodes via a denaturing process whereby the overall mechanism may proceed via contact active mode. Antibacterial effect analysis data (the CFU analysis) of the bulk water that can be treated in the well-plate can only confirm the amount of viable bacteria that are still present in the treated water samples, but does not reveal the fate of those that have been adsorbed by the nanomaterials. It is believed that the majority of the bacteria adsorbed by the TA-CPFs should be dead. To prove this, a series samples of individual types of TA-CPFs can be tested for the disinfection of E. coli-contaminated water in a well-plate system and followed by crushing the particles, and the contents can again be subjected to CF U analysis to determine the viability of the bacteria that are adsorbed by the nanomaterials. This method of determining the bacteria cell viability is comparable to standard procedures of determining the bacteria content in tissue samples for in vivo experiments. It is noteworthy that the bulk water needs to be removed prior to crushing particles.

The use of coordination polymer frameworks, in particular MOFs as fillers in electrospun nanofibers is used demonstrated for gas separation systems. Compared to the conventional method of preparing mixed matrix membranes, electrospinning is a very low cost and simple technique employed in preparing membranes that have relatively high fluxes, porosity, and mechanical strength. This process requires very little material and little post treatment of membrane, thus making this a more environmentally friendly technique. The organic moiety of the MOF and the electrospun polymer are usually compatible, making it possible for the MOF crystals to be distributed evenly at high loading rates with less aggregation. MOF-nanofibrous membranes have been demonstrated in air pollution controls, hydrogen storage, and in other gaseous related works. It is thereby demonstrated that fabricating nanoporous TA-CPs based nanomats, membranes, and filters in large-scale using the electrospinning method is advantageous.

TA-CPFs can be incorporated into polyacrylonitrile (PAN) and polyvinylidene difluoride (PVDF), which are most common commercial filter membranes, to make highly porous and multi-functional CPFs-based nanomats, filters, and membranes. Mechanical properties, thermal and chemical stability towards wastewater filtration and treatment can be evaluated to assess the applicability of these filters for water purification process from non-traditional water resources.

In a typical fabrication process, nanofibers were prepared via electrospinning method by blending TA-CPFs derivatives with polyacrylonitrile (PAN-15 kDa, 10 wt %). After making two solutions separately, PAN/TA-nanomaterials (1:1) solution is prepared by adding 10 wt./vol % of TA-nanomaterials into the PAN solution (10 wt./vol %), followed by stirring for 12 hours whereby a homogenous solution is formed. About 10 mL of a prepared solution is then drawn into 10 mL syringe for electrospinning. The syringe is placed in a syringe pump with a feeding rate of 1 mL/hr. The electrospinning machine is operated at 15 kV. And the distance between the needle tip and collector tip is set at 15 cm. Subsequently, PAN/TA nanofibers are collected on an aluminum foil which is attached to a stainless plate. After drying the nanofibers, characterization can be done using SEM (as shown in FIG. 12) and FTIR to study the morphology and composition of nanofiber composites. In this manner, large-area nanofiber mats can be fabricated by incorporating TA-CPFs.

Water quality monitoring is difficult due to extremely low concentrations of micropollutants, high complexity of water and wastewater, and lack of low-cost, rapid chemical and pathogen detection methods. Rapid multiplex detection of microorganisms and other contaminant is necessary for diagnosis-based disinfection or biofilm control, and heavy metal poisoning, in which treatment decisions are made on the basis of the information from advanced sensors to provide high-efficiency, responsive (on-demand), and targeted treatment. Testing TA-CPFs nanomaterials for a multiplex sensor device that enables contaminant detection, and water quality monitoring for chemicals and pathogens, utilizing a photoluminescence quenching signal as a result of contaminants binding to TA-CPFs functional framework can be advantageous.

TA-CPFs also can act as a fluorescence quencher upon surface adhesion of microbes and chemical contaminants by selective quenching of high photoluminescence intensity that produced at one excitation wavelength. From initial studies, it is evident that TA-NPs and TA-Fe(III) CPFs show broad absorbance in the UV-visible region and high fluorescence emission upon excited at 340 nm and 325 nm respectively. Utilizing TA-CPFs' optical properties, a florescence probe can be fabricated for multiplex target detection. As illustrated in the FIG. 10, the design approach can focus on fabricating a nanoporous TA-CPFs nanomaterials' thin layer on either PVDF and PAN filter mats or transparent flexible substrates. With a drop of contaminated water placed on the surface of the nanomaterials coated substrate, luminescence intensity of the florescence signal is either reduced or enhanced as a result of binding contaminants onto nanomaterials surface. According to one embodiment, the test devices prepared with the illustrated device configuration are tested for series of contaminants presence in produced water and other non-traditional water samples. According to one embodiment, calibration curves with respect to luminescence intensity are first generated with respect to specific contaminants concentrations, prior to validating the sensor for real-time water quality monitoring.

According to one embodiment, in an exemplary device fabrication process, an aqueous suspension of TA-CPFs nanostructures is coated on transparent crosslinked polydimethylsiloxane (PDMS) substrates using a simple and cost-effective spray coating technique, enabling the production of large-area flexible modules. The effect of film thickness of the particles coated membrane, particle concentration, and number of cycling that is needed for detection can be evaluated. According to one embodiment, after exposing coated membranes to the visible light while exciting at a selected wavelength, fluorescence signal is measured.

Embodiments of the presently disclosed subject matter can introduce innovative agro-ecological approach to water treatment from non-traditional water resources, enhancing agricultural and natural resource sustainability and resilience. It can provide for: (1) using a nano-biomaterial as a multiplex nanoadsorbent from agricultural and forest origin products-natural polyphenols; (2) using a multiplex smart fluorescence probe as a point-of-use device for rapid, accurate, and on-site water quality monitoring; and, (3) fabricating molecular sieving sorbents, filters, membranes, and mats with high surface area and high density functionality for selective meatal ion extraction.

Above listed embodiments of the present invention are accompanied with following drawings, schemes, figures, chemical structures, and electron microscopy images. While the methods above have been explained with regard to lithium, the methods as described herein can be implemented with other metals as well with suitable modifications made to accommodate the material being processed.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of synthesizing tannic acid-coordinated Fe(III)-coordination polymer frameworks (TA-Fe(III)-CPFs), the method comprising:
coordinating tannic acid (TA) with a Fe(III) substance to yield a mixture of coordination complexes possessing different coordination stoichiometries between pyrogallol units and Fe(III) units;
subjecting the mixture to ultrasonic vibration for a predetermined period of time to initiate a rapid complex formation reaction; and
forming tannic acid-coordinated Fe(III)-coordination polymer frameworks (TA-Fe(III)-CPFs) from the mixture.

2. The method of claim 1, further comprising:
subjecting the tannic acid-coordinated Fe(III)-coordination polymer frameworks (TA-Fe(III)-CPFs) to a further ultrasonic vibration;
applying a centrifugal force to separate solid particles comprising TA-Fe(III)-CPFs from the mixture; and,
washing the solid particles with water to yield TA-Fe(III)-CPFs nanobeads having nanoporosity.

3. The method of claim 2, wherein a cross-section of a nanobead pore is between approximately 5 nm and approximately 10 nm.

4. The method of claim 2, wherein a cross-section of a nanobead pore is less than approximately 2 nm.

5. The method of claim 1, wherein the ultrasonic vibration is generated by a sonicator.

6. The method of claim 1, wherein a coordination bond is formed between a Fe(III) ion and a hydroxyl unit of a pyrogallol unit of a tannic acid (TA) molecule, wherein a core structure of the tannic acid molecule remains intact.

7. The method of claim 1, wherein a Fe(III) ion binds onto a respective phenol group of a tannic acid (TA) molecule after eliminating a hydroxyl unit of the tannic acid (TA) molecule.

8. A method of synthesizing tannic acid-silsesquioxane nanoparticles (TA-NPs), the method comprising:
functionalizing a pyrogallol unit within each tannic acid (TA) molecule with a silane precursor through Williamson ether synthesis by reacting tannic acid (TA) with an alkoxy silane precursor to form a sol-gel reactive site on the TA molecule, wherein the sol-gel is formed by converting monomers into a polymer dispersed in a colloidal solution via base-catalyzed hydrolysis and condensation;
forming an integrated network site on a periphery of the TA molecule to generate a crude product;
concentrating the crude product by subjecting it to a vacuum;
washing the concentrated crude product with hexane to create a refined product;
treating the refined product with de-ionized water to remove unreacted TA to yield tannic acid-silsesquioxane nanoparticles (TA-NPs).

9. The method of claim 8, wherein the silane precursor comprises organosilane.

10. The method of claim 8, wherein the sol-gel reactive site is formed by alkylating a hydroxy group of a phenol unit present in a tannic acid (TA) molecule with an organosilane precursor.

11. The method of claim 8, wherein a pyrogallol hydroxy group of the tannic acid (TA) molecule is functionalized with a benzyl unit of an organoalkoxysilane molecule.

12. The method of claim 8, further comprising:
dispersing the sol-gel in an aqueous-based solvent to produce a coating ink; and
fabricating a soft dielectric thin film of nanoparticles from the coating ink, the soft dielectric thin film comprising one or more of: a flexible surface, and an irregular surface.

13. The method of claim 8, further comprising:
applying a centrifugal force to separate solid particles from the refined product;
washing the solid particles with water;
treating the solid particles with an ethanol solution; and,
collecting TA-NP particles in solid form.

14. The method of claim 8, wherein a carbonyl stretching of a silane molecule is lower than an ester carbonyl stretching of the tannic acid (TA) molecule.

15. The method of claim 8, wherein a TA-silane molecule portion of the tannic acid-silsesquioxane nanoparticles (TA-NPs) is thermally stable up to 425° C.

16. The method of claim 8, wherein a TA molecule portion of the tannic acid-silsesquioxane nanoparticles (TA-NPs) is thermally stable up to 525° C.
